(19) United States
(12) Patent Application Publication
(10) Pub. No.: US 2013/0286404 A1
(43) Pub. Date: Oct. 31, 2013

(54) METHODS AND APPARATUS FOR ALIGNMENT OF INTERFEROMETER

(71) Applicants: Andrew Cenko, Waterloo (CA); Arsen Hajian, Waterloo (CA); Jeff Meade, Arden (CA)

(72) Inventors: Andrew Cenko, Waterloo (CA); Arsen Hajian, Waterloo (CA); Jeff Meade, Arden (CA)

(73) Assignee: THUNDER BAY REGIONAL RESEARCH INSTITUTE, Thunder Bay, ON (CA)

(21) Appl. No.: 13/885,735

(22) PCT Filed: Nov. 16, 2011
(86) PCT No.: PCT/CA11/50710

§ 371 Date: Jul. 16, 2013

Related U.S. Application Data
(60) Provisional application No. 61/414,044, filed on Nov. 16, 2010.
(60) Provisional application No. 61/434,924, filed on Jan. 21, 2011.

(51) Int. Cl. G01B 9/02

(52) U.S. Cl. CPC G01B 9/02041
USPC 356/508

(57) ABSTRACT

Methods and apparatus are provided for the alignment of an interferometric system. A spatial filter comprising a reflective pinhole is provided at the output of the interferometer, and tilt is measured by a tilt detection subsystem positioned to reimage the pinhole. A shear detection subsystem is positioned to image an offset of the interferometer beams. Tilt and shear offsets are determined by comparing measurements obtained from the tilt and shear subsystems with pre-recorded measurements obtained for an aligned state. The tilt and shear offsets are employed to realign the system using positioning controls corresponding a reduced number of dominant degrees of freedom of the system.

### CROSS-REFERENCE TO RELATED APPLICATION

This application claims priority to U.S. Provisional Application No. 61/414,044, titled “AUTOMATIC INTERFEROMETRIC ALIGNMENT OF AN OPTICAL COHERENCE TOMOGRAPHY SYSTEM” and filed on Nov. 16, 2010, the entire contents of which are incorporated herein by reference, and to U.S. Provisional Application No. 61/434,924, titled “METHOD AND APPARATUS FOR ALIGNMENT OF INTERFEROMETER” and filed on Jan. 21, 2011, the entire contents of which are incorporated herein by reference.

### BACKGROUND

This disclosure relates to methods and apparatus for stabilizing free space interferometry systems. More particularly, this disclosure relates to methods and apparatus for stabilizing optical coherence tomography systems employing free space interferometry.

Optical Coherence Tomography (OCT) is a quickly advancing interferometric medical imaging technology that allows for high-resolution and non-destructive tomographic imaging. One of its primary current uses is for in vivo and ex vivo examination of medical samples, and is often used to study ocular, vascular, respiratory, dental, dermal, neurological, and gastrointestinal diseases. OCT fills an imaging niche between low resolution, high penetration depth imaging techniques like ultrasound (US) and magnetic resonance imaging (MRI) modalities and high resolution, low penetration techniques like confocal microscopy (CM) techniques. OCT provides high resolution imaging (˜1 μm) over 3D volumes spanning several millimeters with minimal sample preparation time. Some primary advantages of OCT imaging include rapid imaging of biological tissue with minimal sample preparation, 3D high-resolution imaging with depth penetrations of several millimeters, and the capability to obtain results in real time, and allowing for fast and minimally invasive identification of many diseases.

Currently, there is often a significant hurdle between state-of-the-art research systems and commercial implementations of OCT systems. In particular, many high end research systems use a free-space optical design that may necessitate frequently stopping to realign the system or special technical expertise to operate the system. Such drawbacks can severely disrupt productivity, and are typically avoided by reconfiguring the system design using fiber optic components to satisfy the reliability needs of a commercial product.

This reconfiguration greatly improves the robustness of the system to external effects but comes at the cost of additional development time and can often reduce the overall system performance. The reconfigured system depends on the robustness of the fiber to maintain system performance in variable environmental conditions, but sacrifices the performance and flexibility of free-space optical designs.

The aforementioned sacrifice in system performance arises from the inherent limitations of fiber optic components. Fiber optics are primarily designed for conveniently transporting light long distances. While very useful for OCT systems, the available optical components and operating wavelengths are heavily limited compared to free-space choices. Current OCT systems implement significant portions of their design in free-space optics, such as the sample focusing system, because of these limitations. The fiber optics are primarily used in the interferometer body, where tolerances are most strict. Unfortunately, by enclosing the light transport path inside a fiber, it can be difficult to modify and enhance an already designed system.

In addition to the limitations in component choices, there can be performance penalties for a fiber based design. Simple off-the-shelf fiber cables quote losses of 0.3 dB (˜6.7%) compared with coated off-the-shelf free space optical losses of less than 1%. In addition, coupling between free-space and fiber based systems, as performed in most current OCT systems, imposes additional losses that can become fairly severe with minimal misalignment. Fiber optics also suffer from poorer control of polarization than free space optics. In order to achieve a strong interference signal, maintaining proper polarization is important. While careful design and polarization controlling devices can mitigate some of this effect in fiber systems, a free-space optical design makes polarization control much simpler. This can be especially important in polarization sensitive OCT applications, such as Mueller OCT systems.

The chromatic variation in the index of refraction of fiber is also substantially different and more significant than that of air, making it important to closely match the length of fiber in each arm of the interferometer to minimize dispersive effects. Because the path lengths in the interferometer already need to be closely matched in an OCT system, the removal of the fiber reduces this additional source of dispersion in the system.

With current trends in OCT technology, higher resolution systems are a large focus of research. This requires extremely broadband light sources to improve the axial resolution of the system. Because the wavelength range that can efficiently propagate through a single mode fiber is constrained by the physical parameters of the fiber, it can be difficult to design a fiber system that provides high throughput with a large spectral bandwidth. This can be especially difficult at short wavelengths, where high lateral resolution can also be achieved. By removing the fiber from the system, standard broadband optical coatings can be used to provide high throughput over large wavelength regions.

One of the main advantages of fiber based designs is the ability to contain large optical paths in an easily manipulated fiber. It is relatively simple to encapsulate many meters of path length in a small coil that can be later stretched a long distance and then coiled again. A free-space optical system likely needs to be larger to accommodate the same path length requirements.

In a free-space system, efficiently travelling long distances can be difficult and can greatly magnify small alignment errors—a small tilt of a beam entering a fiber will cause a small light loss at the far end of the fiber while the same error in a free-space system could be magnified to a fairly large beam shear.

The discrete optics in a free-space system are also more sensitive to positional effects. If a lens moves by a small amount, the beam position and tilt can change by relatively large amounts. These effects are both seen in construction and in use and require special care in interferometric systems. Accordingly, the initial alignment of an interferometer built with free-space optics is significantly more difficult than a fiber based design. Temperature changes of a few degrees are sufficient to cause noticeable alignment changes and can occur simply from the body heat of an operator near the system.

### SUMMARY

Methods and apparatus are provided for the alignment of an interferometric system. In one embodiment, a spatial filter comprising a reflective pinhole is provided at the output of the interferometer, and tilt is measured by a tilt detection subsystem positioned to reimage the pinhole. A shear detection subsystem is positioned to image an offset of the interferometer beams. Tilt and shear offsets are determined by comparing measurements obtained from the tilt and shear subsystems with pre-recorded measurements obtained for an aligned state. The tilt and shear offsets are employed to realign the system using positioning controls corresponding a reduced number of dominant degrees of freedom of the system.

In one aspect, there is provided an alignment apparatus for aligning an interferometer, wherein the interferometer is configured to separate and recombine a first beam and a second beam in free space, and wherein a misalignment of the interferometer is characterized by a reduced set of dominant degrees of freedom, the alignment apparatus comprising: for each dominant degree of freedom: detection means for detecting an alignment associated with the dominant degree of freedom and for providing an error signal associated with the dominant degree of freedom; and a positioning element operatively connected to the interferometer and configured to vary the alignment associated with the dominant degree of freedom; and a controller configured to control each positioning element and maintain alignment of the interferometer based on the error signals obtained from the detection means.

In another aspect, there is provided an apparatus for aligning an interferometer, the interferometer configured to separate and recombine a first beam and a second beam in free space, the apparatus comprising: a spatial filter located at an output of the interferometer, the spatial filter including a focusing optical element and a reflective optical element including a pinhole; a tilt detection subsystem configured to reimage the pinhole for measuring a tilt of the first beam and the second beam; a shear detection subsystem configured to image an offset of the first beam and the second beam for measuring a shear of the first beam and the second beam; and two or more positioning elements configured to vary a tilt and shear of the first beam and the second beam.

In another aspect, there is provided a method of aligning an interferometric system, the interferometric system including an interferometer and an alignment apparatus according to claim 13, wherein the positioning elements of the alignment apparatus are provided to compensate for errors resulting from a reduced set of dominant degrees of freedom for the interferometer, such that one positioning element is provided for each reduced dominant degree of freedom; the method comprising the steps of: a) determining a tilt offset from the tilt detection system; b) controlling at least one of the positioning elements to correct for the tilt offset; c) determining a shear offset from the shear detection system; and d) controlling at least one of the positioning elements to correct for the shear offset.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 provides a schematic of the OCT system, showing the main optical components, and the two sample and backend additional subsystems.

FIG. 2 is a schematic of the sample scanning subsystem.

FIG. 3 is a schematic of the spectrometer backend subsystem.

FIG. 4 provides a series of images showing a comparison of the returned signal from a mirror in the focal plane of the sample arm and a representative scattering sample. Note the greatly increased size of the spot returning from the sample and the residual light from a mirror spot that does not pass through the pinhole.

FIG. 4(a) shows the focused spot from a mirror, with reduced exposure time to avoid saturation.

FIG. 4(b) shows the focused spot from a mirror.

FIG. 4(c) shows focused spot from a mirror through the pinhole.

FIG. 4(d) shows the focused spot from the sample.

FIG. 4(e) shows the focused spot from the sample through the pinhole.

FIG. 5 provides images showing the ability to measure tilt misalignments using the system. The images on the top show the measured offset of the tilt while the plots on the bottom show the signal obtained at the detector. The cross near the image center indicates where the spot should be while the other cross centroids the actual spot. The images on the top are zoomed in views of the tilt sensor and do not show the full field of view.

FIG. 6 provides images that show the ability to measure shear misalignments using the system. The images on the top show the measured offset of the shear while the plots on the bottom show the signal obtained at the detector. The images are heavily enhanced to highlight the edges in printed form. Note that this axis of control only affects the reference arm of the interferometer and so the signal from the sample arm is always present at the same intensity in the plots.

FIG. 7 is a flow chart illustrating a method of automatically aligning an interferometric system.

FIG. 8 illustrates the effect of mirror shifts on a collimated beam, where (a) shows an assumed initial configuration while (b) through (d) show the effects of offsets from this configuration. Solid light grey indicates the collimated beam. The solid rectangle shows the mirror position and orientation while the solid line shows the mirror normal from the center of the mirror. If needed, a dotted line shows the mirror normal at the incident point. Where appropriate, equivalent objects in dark highlight differences from the initial configuration.

FIG. 9 illustrates the effect of various lens shifts, where (a) shows an assumed initial configuration while (b) through (e) show the effects of offsets from this configuration. Solid light grey indicates collimated beams and light grey lines show focusing light. The oval shows the lens position and orientation while the rectangle shows the focal plane of the lens. Where appropriate, equivalent objects in dark grey highlight differences from the initial configuration.

FIG. 10 provides an optical layout to illustrate the adaptation of the method to a wide range of interferometric devices. Black arrows indicate the direction of light propagation.

### DETAILED DESCRIPTION

Various embodiments and aspects of the disclosure will be described with reference to details discussed below. The following description and drawings are illustrative of the disclosure and are not to be construed as limiting the disclosure.

Numerous specific details are described to provide a thorough understanding of various embodiments of the present disclosure. However, in certain instances, well-known or conventional details are not described in order to provide a concise discussion of embodiments of the present disclosure.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately”, when used in conjunction with ranges of dimensions of particles, compositions of mixtures or other physical properties or characteristics, are meant to cover slight variations that may exist in the upper and lower limits of the ranges of dimensions so as to not exclude embodiments where on average most of the dimensions are satisfied but where statistically dimensions may exist outside this region. It is not the intention to exclude embodiments such as these from the present disclosure.

Embodiments disclosed herein provide methods and apparatus that allow the automatic monitoring and control of the alignment of an interferometric optical system, enabling practical, rugged and commercial free space interferometric optical systems that deliver performance similar to customized research systems without requiring the use of fiber optics. Systems incorporating the methods and/or apparatus of the present embodiments can be adapted to support high throughput and allow for significant system customization. In particular, embodiments provided below may enable the automatic control of alignment without any user interaction over a large thermal range, and can further compensate for misalignments during initial system construction or resulting from shock events. Accordingly, such systems may deliver controlled optical stability with minimal interruption to a normal user's workflow.

The forthcoming disclosure illustrates embodiments involving the non-limiting example of an OCT system. The basic principles of an OCT system are first described, after which embodiments providing methods and apparatus are disclosed whereby a free space OCT system is adapted for automated stability control.

The example system described below is a free space OCT interferometer that can automatically maintain its alignment, allowing for the use of a free-space optical design outside of tightly controlled laboratory environments. The system supports shortened OCT imaging times by increasing first-time accuracy of the scan, removing artifacts and other effects that can compromise the resolution of the scan. The system corrects for small to moderate misalignments caused by temperature fluctuations, shock events, and other perturbations. Selected embodiments also provide minimally invasive monitoring and correction hardware enhancements along with methods of calibrating this hardware for improved performance.

While selected embodiments disclosed below relate to high-performance medical interferometric imaging devices such as OCT devices, it is to be understood that the scope of the embodiments disclosed herein is not to be limited to such heuristic and non-limiting examples. The proceeding embodiments may be readily adapted to a wide range of free space interferometric devices. Furthermore, although the embodiments provided herein relate to free space interferometric systems, it is to be understood that systems according to the embodiments disclosed below may also include non-free-space (i.e. optically guided) elements, provided that at least a portion of the system involves free space propagation between optical components. For example, an interferometric optical system according to embodiments provided herein may include a free space interferometric subsystem that connects to a guided subsystem for a portion of the optical path, such as a free space interferometer having in its sample arm a guided optical subsystem such as a catheter housing an optical fiber.

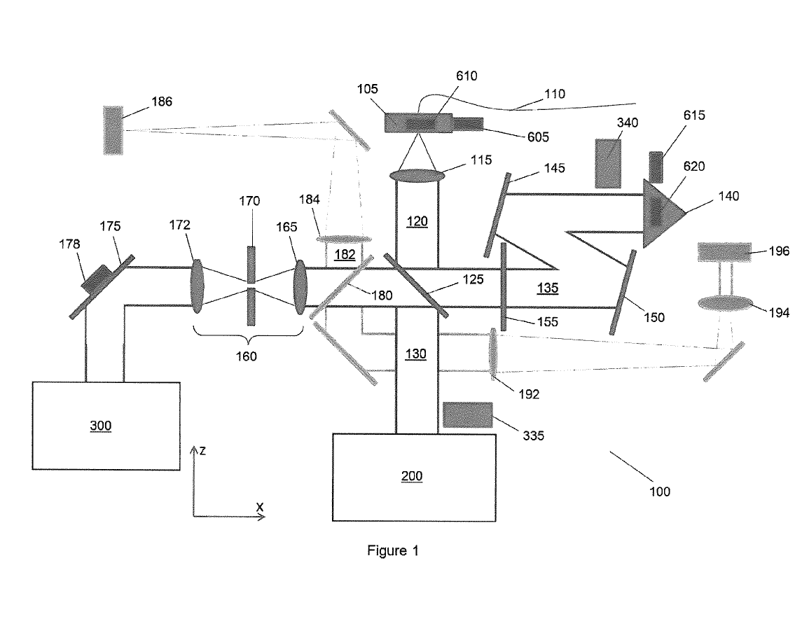

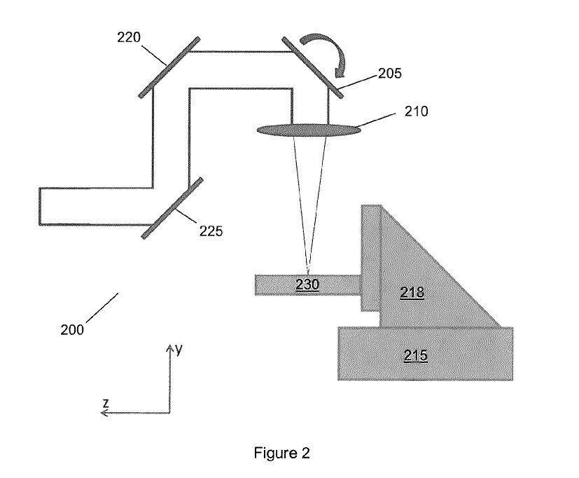

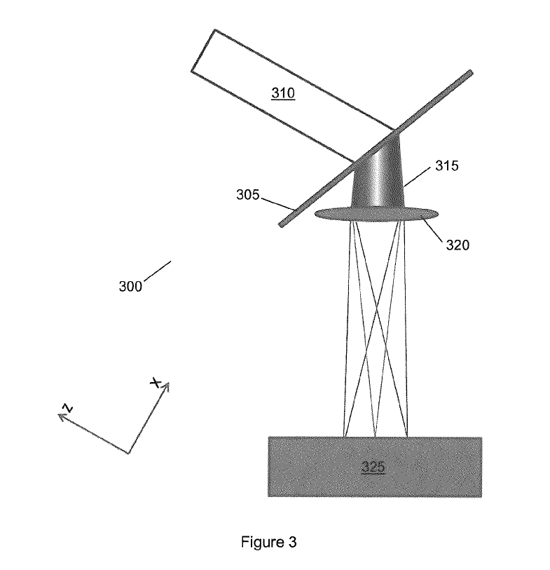

Referring now to FIGS. 1 to 3, an example implementation of an OCT system is illustrated comprising three main sections. The first section, shown in FIG. 1, is the main interferometer body 100, which splits and recombines the light and allows interference to occur. The second section, shown in FIG. 2, is the sample scanning system 200. This system takes the light from the sample arm of the interferometer and directs it onto the sample under observation (typically using via a scanning operation), allowing for a 3D reconstruction of the sample structure. The third section, referred to below as the backend 300, is shown in FIG. 3 and comprises a spectrometer that disperses the light from the interferometer and acquires the spectral interference data.

The light from the optical source 105 (shown as a fiber launcher for emitting light from a fiber coupled semiconductor laser diode) enters system 100 through a single mode fiber 110 matched to the laser diode. The FC-APC coupler on this fiber 110 is designed to minimize back reflections into the laser diode 105, which can damage the device. This fiber has a numerical aperture (NA) of 0.14 and is collimated by a near-infrared achromatic lens 115 (Thorlabs AC254-75-B f=75 mm) to provide a collimated beam (with a diameter of 21 mm). The collimated beam 120 is then sent into the main interferometer body.

Inside the interferometer, the collimated beam 120 is split using a beam splitter 125 (Thorlabs BSW17 non-polarizing 2″ plate) and the two collimated beams 130, 135 are directed to the sample system and the reference arm, respectively. The reference arm primarily consists of a retroreflector 140 (CV! Melles Griot CCH-25.4-1-LEBG 1″ hollow retroreflector), several beam steering mirrors 145, 150 (Thorlabs PF20-03-P01) to compress the beam path, and a neutral density filter 155 to reduce the reference intensity. The light from the reference arm is reflected from the retroreflector 140 and returns to the beam splitter 125 for recombination.

Referring now to FIG. 2, the sample scanning system includes a galvanometer scanning mirror system 205 (Nutfield QuantumScan-30 1″ galvanometer), a sample focusing lens 210 (Thorlabs AC508-100-B 100 mm 2″ NIR achromatic), and a motorized translation stage 215 (Nanomotion FB050 50 mm stage) attached to angle bracket 218. A pair of mirrors 220, 225 is employed to dogleg the beam and direct it to the galvanometer 205, which is provided to enable lateral scanning of the beam across the sample 230 (preferably with micron level resolution) by changing the angle of incidence on the sample focusing lens 210. The light reflecting off the galvanometer 205 enters the sample focusing lens 210 and is focused onto a sample platform mounted on the translation stage 215. The translation stage 215 enables the positioning of the sample 230 in a direction orthogonal to the galvanometer scan direction (the Nanomotion translation stage employed in the example system provides 10 nm resolution and 50 nm repeatability). Together, the translation stage 215 and galvanometer 205 support scanning the beam across the sample 230, with the OCT interferometer providing depth information for a full 3D image.

An additional translation stage (not shown; New Focus 9064-X) provides sample focus adjustment (±14 mm using the equipment quoted). The beam incident on the sample 230 scatters back into the sample focusing lens 210 and returns to the beam splitter 125 for recombination.

When the light from both arms returns to the beam splitter 125, half the light is returned towards optical fiber 110 (and lost) while the other half is sent to a spatial filter system 160. The spatial filter system 160 comprises a lens 165 (with a Thorlabs AC254-75-B 75 mm NIR achromatic) which focuses the collimated beam onto a pinhole 170 (Newport 910-PH10 10 μm). Pinhole 170 ensures that only the portion of the beam returning from near the diffraction-limited cone scattered by the sample passes into the backend 300 of the system. The light transmitted through the pinhole 170 is recollimated with lens 172 (Thorlabs AC254-75-B 75 mm NIR achromatic) and enters the spectrometer backend 300.

Referring to FIG. 3, in spectrometer backend 300, a grating 305 is provided to spectrally and spatially disperse the transmitted light. In the example experimental system used, the grating selected was a custom Kaiser Optical grating with 1,200 lines per mm (I/mm), and was designed to maximize the spectral throughput from the laser diode light source. The collimated beam 310 passes through the grating and the dispersed light 315 is focused by a lens 320 (Thorlabs AC508-150-B 150 mm NIR achromatic). The focused light is directed onto and detected by a line scan camera 325 (Basler Sprint spL2048-70 km) and interfaced with a personal computer using an image acquisition board (not shown; National Instruments NI PCIe-1429 Camera Link).

In a system involving a fiber optic based design, most of the alignment is handled by the high precision couplers attached to the fiber optic components. This makes for simple assembly and a robust implementation but requires the use of fiber optics in the interferometer. In the present free space system shown in FIGS. 1-3, the alignment of the OCT system will drift if not controlled. The following description addresses the design of an automatic alignment system for maintaining the stability of the interferometric system.

To obtain interferometric fringes on the line scan detector, it is important for spatial coherence to be achieved and maintained at the detector. It is also important to ensure that the light paths continue to propagate through the system in the presence of alignment perturbations. In the present frequency domain (FD)-OCT based design, the temporal coherence constraints are limited by the bandwidth of a pixel in the backend spectrometer 300 rather than by the bandwidth of the light source. In this case, optimal use of a 2048 pixel detector with a 100 nm bandpass would provide a pixel bandwidth of approximately 0.05 nm. The laser diode light source has a central wavelength of 850 nm, providing a coherence length of about 15 mm. Maintaining the beams within such a coherence length is readily achievable. Even with bandwidths many times this optimal value, millimeter level offsets are generally acceptable.

The spatial coherence constraints of the system are determined by the angular size of the source emitted from the fiber launcher 105 and the pinhole 170. Both of these are on the order of 10 μm with a 75 mm focal length focusing lens 165. This yields a coherence area of about 45 mm² for the shortest wavelengths of the source. This corresponds to a circular region with a diameter of approximately 7.5 mm. This is about one third of the beam diameter and is also readily achieved.

Although maintaining coherence is readily achievable, small tilt errors can greatly offset the position of the spots in the system. Assuming 10 μm spots are obtained with a 75 mm focal length lens 165, an induced tilt of 30 arcseconds would be sufficient to offset the focus by an entire spot width. Such a 30 arcsecond tilt would be induced by about a 2 μm skew in a 1″ diameter optic (and even less in some optics). A small fraction of this distance is sufficient to significantly affect the system performance. Such small errors are likely to occur and it is important to provide a feedback mechanism for their correction.

The timescales for relative system alignment are estimated as follows. A typical lens mount (such as a Thorlabs LMR1) has an aluminum base height of about 10 mm. The coefficient of thermal expansion of aluminum is about 23×10⁻⁶ m/m° C. near room temperature. A 1° C. temperature change would induce a shift of 0.2 μm in this mount. When the combined effect of many such mounts and the hardware required to affix these mounts in the system is considered, a temperature changes on the order of 1° C. can have a relatively large effect on the efficiency of the system. Without thermal isolation, a person's body heat near the system could be enough to disrupt alignment. Without significant thermal isolation, alignment will drift as the system temperature changes.

Because all the components in the system are attached typically to a fixed substrate (such as an optical bench or breadboard), a small amount of vibrational isolation should result in most of the misalignment sources arising from temperature variations. Because it is expected that the system is to be used indoors, it is likely that the temperature variations will occur on long timescales. For example, in the laboratory environment in which the present system was built, it was possible to use the system with people in the room for several hours without significant image degradation. Nonetheless, alignment was found to improve system throughput, especially when performed before beginning any data collection.

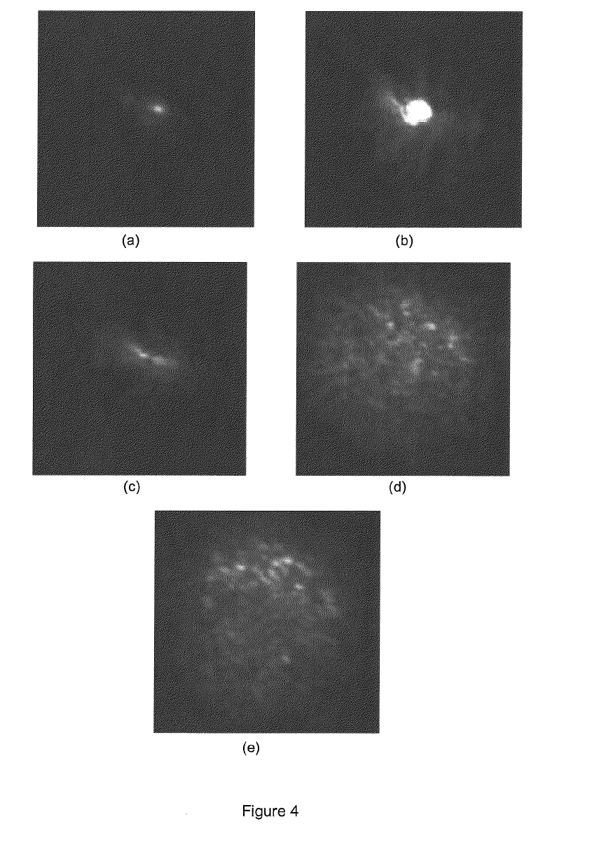

Due to the nature of OCT imaging, several mitigating factors reduce the tolerances placed on the alignment system. First, the light from the sample returns with a much larger effective spot than the specular reflection off a mirror surface (see FIG. 4). While some of this is multiply scattered light, the majority of the signal near the center of this spot is useful singly scattered light. Although it is desirable to isolate a small portion of this light to focus on a specific lateral point in the sample, a small misalignment will primarily shift the point of interest rather than significantly reducing the returned signal.

On a similar note, the light in the reference arm generally needs to be significantly reduced (for example, using one or more neutral density (ND) filters) to provide an appropriate signal level to mix with the sample light. The primary result of a misalignment in the reference arm is a reduction in signal strength, with a secondary spectral shift due to an imperfectly achromatic lens. The signal strength reduction is readily compensated by a change in ND value and experiment calibration data can be employed to mitigate the spectral shift effect.

These two effects, when combined, limit the effects of instantaneous system misalignment, with the result that the more stringent requirements relate to the long term stability of the system.

The inventors have found that the important degrees of freedom for alignment of an optical interferometric system can be significantly reduced by assessing the relative contribution of each apparent degree of freedom to misalignment. Each component in an optical system has 6 degrees of freedom: translation and rotation axes for the x, y, and z dimensions. Aligning every possible axis of the components in a complex system is unfeasible—for example, well over 50 axes of control would be needed to accomplish this task. One aspect of the present auto-alignment systems and methods is the reduction of the required control axes. This may be achieved by identifying insensitive degrees of freedom and combining complementary degrees of freedom into a smaller number of controls. It is generally assumed that the errors to be corrected are reasonably small, such as those caused by moderate temperature fluctuations or by small shocks to the system.

The identification and reduction of the relevant degrees of freedom can be performed as follows. First, the degrees of freedom that cause a noticeable effect for the various types of components are identified. As an example, each of the optical components is rotationally symmetric, immediately removing one degree of rotational freedom from consideration. Table 1 enumerates the effect of the various degrees of freedom on the optical components. This table makes assumptions based on the design—for example, that all of the main OCT system mirrors operate on collimated light.

TABLE 1
The effect of degrees of freedom of the various optical components on
the optical alignment of the system. The degrees of freedom are
referenced to the centers of the optical components.

| Degree of | Fiber | | | | |
|---|---|---|---|---|---|
| Freedom | Launcher | Pinhole | Lens | Mirror | Retroreflector |
| Translation X | Tilt | Tilt | Tilt | — | Shear |
| Translation Y | Tilt | Tilt | Tilt | — | Shear |
| Translation Z | Focus | Focus | Focus | Shear and | Path Length |
| | | | | Path | |
| | | | | Length | |
| Rotation X | Shear | — | Focus | Tilt | — |
| Rotation Y | Shear | — | Focus | Tilt | — |
| Rotation Z | — | — | — | — | — |

With small errors, the optical effects in the system may compound. As an example, if a mirror is expected to induce tilt, then the mirror tilt will be added to any original beam tilt. As long as the errors remain small, this error may be corrected in the system by adjusting a single component with the opposite effect. This principle allows for the simplification of the correction protocol.

Accordingly, the reduction of the degrees of freedom of the system involves determining how the relevant degrees of freedom will affect the system alignment and performance. For simplicity, in the context of the present example, this is described by analyzing the system in terms of five smaller subsystems: fiber collimation, the reference arm, the sample arm, recombination, and the spectrometer.

Fiber collimation primarily consists of the fiber launcher (shown generally at 105) and a collimating lens 115. From Table 1, it is evident that the important effects to consider are focus, shear, and tilt. The depth of field of the collimation lens is large enough that most focus misalignments have a negligible effect on the system—as an example, the thermal expansion of aluminum gives provides a 15° C. window before the depth of field is exceeded in the present example. In addition, the focus of the sample arm compensates for a defocus entering the sample arm and an adjustment of attenuation of the neutral density filter 155 in the reference arm can compensate for lost light passing through the pinhole. Any shear introduced at this point will be small relative to the pupil diameter and will affect both arms of the interferometer equally, making any effect small. Tilts introduced here are very significant, though, with degree level temperature fluctuations shifting the spot location by large fractions of the spot size.

Accordingly, because of the sensitivity of the fiber launcher 105 to tilt, tilt corrections are provided at the fiber launcher. Implementing system tilt control is possible by moving the position of the input fiber relative to the collimating lens. The tilt corrections are achieved by providing a pair of motorized horizontal 605 and vertical 610 translation stages, which, through the translation of the fiber launcher relative to the collimation lens 115, facilitate tilt correction of the source beam. In the example system shown in FIGS. 1-3, a New Focus 8051 pico fiber launcher 105 was employed for positioning the fiber with 30 nm step sizes over a ±3 mm range. With the 75 mm collimating lens 115, this allows for tilt adjustments of approximately 80 milliarcseconds over a ±2° range. This degree of tilt control is sufficient to maintain alignment at a high level. By manipulating the tilt through the fiber launcher using the motorized translation stages 605 and 610, the dominant residual misalignment may be corrected so that the beams pass the OCT signal through the pinhole and into the spectrometer backend.

Turning now to the reference arm, the light partially reflects off the beam splitter 125 and a pair of fold mirrors (150, 145) and then encounters the retroreflector 140. Because of the design of the retroreflector, light entering the retroreflector is reflected with the same tilt (with less than one arcsecond error) but offset in shear by double the original amount. The long path length in the reference arm also converts any tilts into a small shear. By reflecting off of the fold mirrors 145 and 150 twice, any residual tilt effect is removed, but the mirrors can still induce additional shear. Overall, only the tilt induced by the beam splitter 125 will affect the tilt of the reference arm output.

To overcome the shear that can be induced in the reference arm, motorized shear control is integrated to the retroreflector 140 to enable shear correction. This correction enables control of the overlap of the reference 135 and sample 130 beams. The shear corrections are achieved by providing a pair of motorized horizontal 615 and vertical 620 translation stages, which, via translation of the retroreflector 140, enable shear compensation in the reference arm. In the case of the present example, mounting the retroreflector on two orthogonal translation stages (New Focus 9067-COM) with two attached New Focus 8302 picomotors allows for shear adjustment of the returning reference beam. The New Focus 8302 picomotors provide for ±0.5″ of translation with 30 nm step sizes, allowing the system to maintain coincidence at a small fraction of the beam diameter.

Regarding the sample arm, the collimated beam 130 entering subsystem 200 (shown in FIG. 2) reflects off mirrors 225 and 220 and is then focused onto the sample via lens 210. In the case of OCT, the primary performance concern relates to the light that back reflects from the sample in a single scattering process. This is light that is reflected back the same way it enters, which ensures that light entering the sample arm returns along the same path it enters. Therefore any alignment errors in the sample arm correct for themselves as the light travels back along the path it enters. The light then reflects off of the beam splitter 125 and gains the same tilt induced before light entered the reference arm.

After passing through the reference and sample arms, the light beams are recombined through and focused through the spatial filter pinhole. At this point in the system, the following misalignments may exist: an initial tilt and shear introduced by the fiber collimation, tilt induced by the beam splitter 125, and shear induced by the reference arm. The shear in the reference arm can be corrected through motorized shear control in the reference arm, as noted above. This leaves a tilt and small shear that may exist in the beam. The residual shear will be a small fraction of the collimated beam diameter and should cause little issue. The tilt will determine the spot location and it is important to ensure that the spot location and pinhole location coincide.

It was found by the inventors that frequent alignment of the spectrometer is not generally required—adjustment of the spectrometer was not found to be needed over a timescale of many months despite performing tilt and shear correction in the interferometer. Temperature testing, however, revealed a need for alignment with large temperature changes, and such alignment primarily involved vertical position on the focal plane, which can be adjusted by tilting one axis of the fold mirror 175. Because of the small vertical height of the detector, this is the most sensitive degree of freedom in the spectrometer. Horizontal positioning is relatively insensitive due to the large focal plane width (assuming spectrometer calibration is performed), the depth of field is sufficiently large that focal effects are minimal, and any shear induced will also be minimal.

Accordingly, for environments with in which large temperature fluctuations are expected, an additional axis of control may be provided on the fold mirror feeding the spectrometer, as noted above. A single motor 178 (e.g. a Picomotor) attached to the vertical axis of a mirror mount (e.g. Thorlabs KM200 kinematic 2″) provides the control flexibility for this axis. With the goal of maintaining light on a detector with large system variations, feedback may be provided by simply employing the final system detector to correct for offsets in this axis.

Despite all the potential locations for misalignments in the system, the preceding analysis suggests that two axes of tilt control and two axes of shear control are sufficient to adequately maintain system alignment. With large temperature variations (larger than those seen in the laboratory environment under normal conditions), an additional axis is required to control the vertical position of the beam incident on the spectrometer.

In order to maintain system alignment, additional hardware providing feedback to monitor and adjust the alignment is required. To minimize the cost and complexity, the number of alignment components should be minimized. This involves identifying the unique degrees of freedom in the system and providing monitoring and control devices for them.

The preceding examination of the system shows that two degrees of alignment freedom should be sufficient to monitor and maintain interferometer alignment. As noted above, alignment can be maintained by adjusting the tilt of the beam entering the interferometer to ensure the spots in the system pass through the pinhole. In addition, the retroreflector position can be adjusted to ensure that the two interferometer arm beams are coincident. By monitoring and controlling these four degrees of freedom (vertical and horizontal tilt and shear), it is possible to correct for the dominant system drifts. By aligning the system at the pinhole, it can be ensured that a clean interferometric signal enters the backend with both the reference and sample beams coincident.

In addition to adjusting the system alignment, it is important to measure the deviation from proper alignment and determine the required corrections according to a feedback scheme. Ideally, the system should be able to monitor alignment at all times while being minimally invasive. Because it is expected that the alignment drifts will occur over a long time frame relative to the acquisition rate of the system, a small fraction of the light from the system may be split off to monitor the system alignment. For example, a 0.2% anti-reflection (AR) coated beam sampler 180 may be employed to maintain a sufficient frame rate for an alignment measurement system while maintaining the very high system throughput.

In order to monitor the presence of a tilt offset, a reflective pinhole is employed and a reimaging system is implemented. Placing the beam sampler 180 before the pinhole focusing lens 165 but after the beam splitter 125 sends an image of the pinhole plane out of the beam path of the interferometer as collimated beam 182. By focusing this light with lens 184 (Thorlabs AC254-300-B 300 mm focal length achromatic) onto an imaging detector 186 (IDS model UI-1225LE-M) an image of the pinhole is obtained (in the present case, the pinhole image is provided with a 7 pixel diameter). This allows for the measurement of tilt offset at the sub arcsecond level. Adjusting the focal length of this imaging system allows one to trade off measurement accuracy for measurement speed.

Because the beam sampler reflects the light reflecting off the pinhole and the light entering the spatial filter system in opposite directions, the same beam sampler may also be employed to image the pupil offset of the reference and sample beams. Imaging these beams through a beam reducer (comprising lenses 192 and 194) with another imaging detector 196 allows us to measure the coincidence of the sample and reference collimated beams 130 and 135. By adjusting the parameters of the beam reducer, the imaging speed versus the measurement accuracy can be optimized.

One of the important features of the system is the ability to determine alignment errors and to automatically correct for these errors. Errors will be manifested as offsets from the expected positions of the beams on the alignment cameras. By quantifying these offsets using a feedback scheme, the system can automatically determine the corrections that are needed to improve the system alignment.

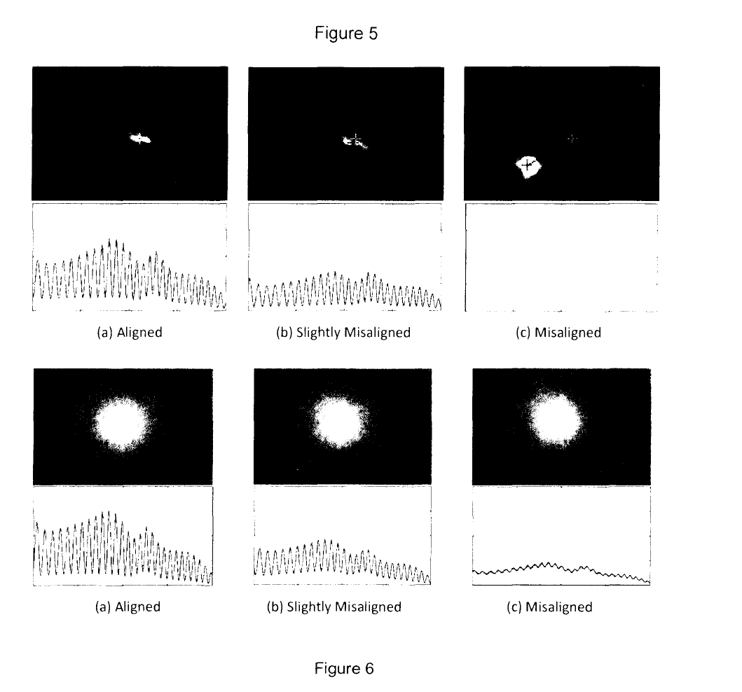

FIGS. 5 and 6 show the ability of the system to detect alignment offsets and the effect the offsets have on the final interferometric and spectrally resolved signal. FIG. 5 shows various levels of tilt offset detected by the tilt monitoring system described in the examples provided herein. As the tilt offset increases (increased distance between the tilt measurement crosshairs), less light is transmitted through the pinhole. By moving the tilt controls to place the offset spot back on the alignment crosshairs, the lost signal can be recovered. FIG. 6 shows various levels of detected shear offset by the shear monitoring system. A crosshair with a small line indicates the direction and magnitude of the offset corresponding to the signal losses detected in the lower images. By correcting the offset, it is possible to recover the lost signal and return to the original signal strength.

The system tilt is manifested as a positional offset of the focused spot on the pinhole plane. An offset of this spot from the pinhole produces two main effects: the centroid of the reflected light off the pinhole plane shifts and the intensity of the reflected light increases (due to less light passing through the pinhole). The goal of the automatic alignment system is to determine the correction to compensate for any tilt offset induced in the beam.

If a perfectly focused spot from the fiber input is reimaging on the pinhole, it will resemble an Airy disk, the diffraction pattern caused by the finite aperture optics. It will have a very bright core (which is the signal to be passed through the pinhole under an aligned state) along with much dimmer rings. If further imperfections from a diffraction limited spot occur, they will pull light from the core into the wings—and such light outside the core is the light that is to be blocked with the pinhole.

The core of the Airy pattern contains approximately 84% of the total intensity, with the first ring containing approximately 7% and the second ring containing approximately 3%. Accordingly, even in the ideal case, a significant fraction of the incident light will be reflected by the reflective portion of the pinhole mount and provide useful a signal for alignment monitoring. Despite this, the required dynamic range for monitoring the entire Airy pattern is large—the peak intensity of the first ring is less than 2% of the peak intensity of the central core. The equipment employed in the present example provided included a detector with only 8 bits of discrimination (256 levels), with the consequence that obtaining sufficient contrast on the rings will cause saturation in the core if the beam core fails to pass through the pinhole.

Assuming the system begins in an aligned state, it is desirable to maintain the position of the focused spot on the pinhole plane. It is important to be able to identify the desired position and maintain such a position. To achieve this, an appropriate direction and magnitude of corrective motion for any offset should be determined. With a fixed sample in the system, the pattern of light on the pinhole plane stays constant. Changing the tilt of the system shifts this pattern in a deterministic direction. The centroid of this pattern provides an indicator of the offset from the desired position.

In calculating the centroid, many different methods can be employed. Two example methods are provided below. When a bright and clean spot illuminates the pinhole (such as with the reflection off a mirror in the sample arm, see FIG. 4(a)), weighting the centroid by the intensity of the pixel value enhances the accuracy by accounting for the brighter center of the spot. However, when a more irregular sample is placed in the sample arm (providing a reimaged spot similar to that in FIG. 4(d)), intensity weighting can greatly skew the centroid location. It has been found that simply thresholding the image and centroiding the thresholded pixels without weighting provides a superior response in this case—and the reduced information per pixel is believed to be offset by a larger number of illuminated pixels.

Despite the potential for saturation when the core is not optimally incident on the pinhole, the exposure time can be set to properly image the position when the light passes through the pinhole. It has been found that the 8 bit imaging camera employed in the experimental testing of the system still operates well when saturated by the core, allowing sufficiently accurate measurements to move the core into the pinhole according to an automatic alignment protocol. As the core moves into the pinhole, the light diminishes and eliminates the saturation, and it is still possible to measure the correct offset. If the exposure time is set to properly image the core, the signal will be too dim for proper measurement when the core enters the pinhole. In another embodiment, an adaptive exposure time method could be employed to provide improved dynamic range, where the exposure time is determined by the pixel intensity and is selected to avoid saturation.

The shear offset measurement system images the collimated beams in the interferometric system. The shear offset system is employed to ensure that both beams in the system pass through the system together and pass through the focusing lens be imaged onto the pinhole.

Identifying the two separate beams can be easily (but invasively) performed by using beam blockers (FIG. 1 shows beam blockers 335 and 340 that can be inserted into the collimated beam paths 130 and 135, respectively). Fortunately, the two pupils do not change significantly with small shears. By storing the individual pupil images, it is possible to compare shifted summations to a combined image to extract the position of each pupil, without blocking each individual beam and halting the overall system. The required shift to generate the combined image provides the offset of the pupil from the original position.

In one embodiment, an alignment correction algorithm involves assuming that an initial satisfactory alignment state is known and maintaining that alignment state under feedback. While such an algorithm will be useful when the system is operated from an initially aligned state (such as when the system is first assembled), the interferometric system will naturally undergo misalignments and it is useful to also provide a method of determining a suitable initial alignment position.

As the present embodiment is primarily concerned with obtaining a suitable signal from the final detector, this detector can be used (at least in part) as a source of feedback information to assess the system alignment. One limitation is that the alignment must already provide sufficient light to this detector—the light must already be at least partially passing through the pinhole. The large field of view of the alignment cameras allows us to sufficiently align the system for signal to reach the final camera even if corrections are needed for better alignment. Once a signal is obtained on the final detector, this signal can be employed to improve the alignment and calibrate out any accrued alignment system errors.

In one embodiment, the initial alignment method is achieved as follows. By focusing on a mirror in the sample arm, a focused spot resembling an Airy pattern is obtained, characterized by a very bright core with a fading intensity farther from the center (see FIG. 4(a)). By blocking the reference arm with the beam blocker 340 and adjusting the tilt motors 605 and 610, it is possible to adjust the amount of light returning from the sample arm mirror that passes through the pinhole, where this adjustment is made without interference effects caused by the reference arm. Because the spot core possesses a smooth profile, a simple gradient following algorithm with reducing step sizes is sufficient to maximize the sample signal. This measurement can be performed by the final system camera (325), ensuring that we maximize the signal detected by the final system and not rely entirely on the alignment system for calibration.

Once the sample arm is aligned, the shear control may be adjusted to align the reference arm. To avoid interference effects affecting the measured signal, the sample arm is blocked using beam block 335. Again, a simple gradient following algorithm with reducing step sizes is sufficient to maximize the reference signal. In one embodiment, the beam blocks 335 and 340 are motorized, enabling automated insertion of the beam blocks into the respective beam paths, thus enabling full automation of the present initial alignment procedure.

In a similar fashion, the vertical position of the light hitting the spectrometer may be adjusted. As this control affects both arms equally, the signal from both arms may be employed to maximize the total throughput. The interference between the two arms should be substantially constant at this point, and therefore the blocking of individual arms is typically not necessary.

After having obtained an initial alignment state, the alignment method according to one embodiment monitors changes from the initial state and corrects for alignment errors using the alignment feedback and controls. In one embodiment, when the system is properly aligned, the system state is recorded, for example, in a series of variables, where the recorded system state enables the determination of offsets from this state. Even with large system changes (for example, including alignment offsets that render the system completely unusable), the recorded offsets allow for the system to be quickly returned to a state that is close to the previously aligned state.

In one embodiment, the automated alignment system determines the initial alignment state by accessing primary system components (such as the final OCT detector) to accurately determine a suitable alignment state with desired performance. This optimization is an intrusive process and it may place limitations on the range of parameter space in which the system may reside prior to the automated determination of the initial alignment state. Moreover, due to its intrusive nature, such a method is not suitable for constant system monitoring, but provides a suitable initial state and can correct for errors accruing in the alignment system. Combined with the primary automated alignment scheme, the overall system and method are generally able to maintain high quality short and long term system alignment.

During operation of the alignment method, alignment offsets from an initial state are determined. Given the calculated offsets, the errors are corrected by moving the various alignment motors 605, 610, 615 and 620 to translate the input source and retroreflector for the correction of tilt and shear, respectively. However, in order to determine the appropriate corrections, it is important to calibrate the alignment system in order to obtain the relationship between camera offsets and motor movements.

Such a calibration may be performed manually or in an automated fashion, with the resulting calibration parameters stored and accessible by the computing system that is employed to automate the alignment method. In one embodiment, the calibration is performed automatically by the alignment software interface, although this requires the operation of the system to be suspended. By moving each axis of the system individually by a known amount and computing the apparent movement, it is possible to determine the effect each axis has on the system and thus calibrate the system. It is important to note that the mount loading forces may cause forward and reverse motor movement commands to react differently (e.g. due to motor backlash), which may require a different calibration procedure for each direction. The calibration may be stored in a multitude of different formats, including, but not limited to, a look-up table (for interpolation) and a mathematically fitted relationship.

The motor calibration data and the measured offsets are then employed to determine an appropriate motor response (e.g. motor commands, steps, and/or drive voltages and time intervals) to improve the current system alignment. By iteratively measuring the offset and correcting the offset, a feedback loop may be employed to maintain alignment. In one embodiment, damping (for example, reducing the commanded positions by a fixed factor, such as 25%, to slow the convergence and prevent overshooting) is provided to compensate for small errors or drifts in the motor calibration (with an increased response time).

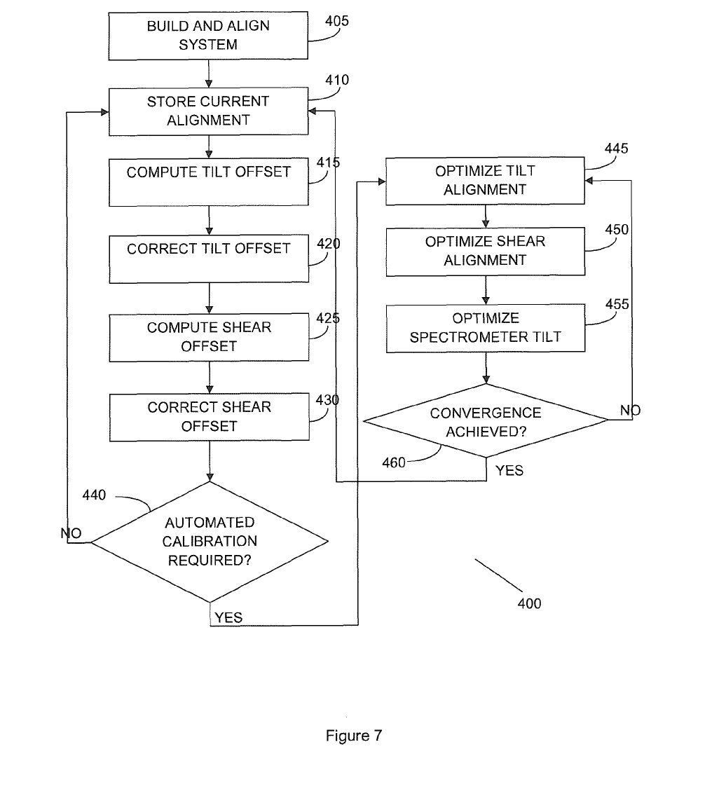

With reference to FIG. 7, a flow chart 400 is provided that illustrates the steps involved in the automated alignment method disclosed above. In step 405, the interferometric system is constructed and aligned. The initial alignment state is stored in step 410 based on the positions of the spot and beam centroids in the tilt and shear imaging cameras, respectively. The system is then operated, and after a given time interval, the alignment of the system is assessed. In step 415, the tilt offset is calculated based on the deviation of the spot centroid as measured using the tilt imaging camera. Using the appropriate calibration data, the tilt correction system is activated in step 420 to correct for the tilt offset. In step 425, the shear offset is calculated based on the observed beam shear in the shear imaging camera. The calculated shear offset and appropriate calibration data are then employed in step 430 to correct the observed shear. While steps 415 and 420 are shown as occurring prior to steps 425 and 430, it is to be understood that the order of performing these pairs of steps may be reversed.

After having performed the tilt and shear corrections, a determination is made in step 440 as to whether or not an overall system calibration should be performed. As noted above, such a determination can be made based on a measured signal indicative of the system performance, such as the signal obtained at the spectrometer. This determination can be made by examining the throughput from a well calibrated sample, examining the reference arm intensity compared to a previously calibrated amount, or other methods to determine a decrease in system sensitivity. The shear and tilt are then optimized in steps 445 through 455, which may be performed by blocking the individual interferometer beams serially and optimizing each beam separately. If sufficient convergence has been obtained in step 460, the current alignment state is stored once again in step 410, and the tilt and shear offset correction portion of the method is repeated. If convergence has not been reached, steps 445-455 are repeated.

In one embodiment, the alignment feedback loop may be configured to pause prior to performing a given alignment correction in order to obtain human verification. Using a user interface that is interfaced with the computing system performing the automated alignment method, a human controller may verify that a calculated correction is reasonable before allowing the system to implement the correction. By repeating this process for both tilt and shear, the system is able to recover and maintain system alignment. In another embodiment, corrections are automatically performed without requiring human input for verification.

Although the preceding embodiments were described in the context of an example implementation of a system with specific examples of system components and performance figures, it is to be understood that the embodiments are not limited to the examples provided. A wide variety of system configurations and components may be employed without departing from the scope of the claimed embodiments. For example, the OCT system may involve a time-domain interferometer as opposed to a frequency domain interferometer. In another variation, the optical source may comprise direct emission from a laser, where the relative position of the laser is controlled for tilt alignment using motors 605 and 610.

It is important to recognize that the system is not limited to OCT system applications, and may instead be adapted to provide systems and methods for the automatic alignment of a wide variety of interferometric optical systems. Generally speaking, by isolating the necessary degrees of freedom and implementing measurement and correction hardware, an alignment system can be implemented according to the embodiments disclosed herein.

As described above in relation to the OCT example, the first objective in the design process is the identification of the dominant degrees of freedom in a given interferometric system. Such dominant degrees of freedom are the degrees of freedom that have a substantial effect on system performance if alignment changes occur. Although the dominant degrees of freedom depend on the actual system configuration employed, general guidelines for the identification of the dominant degrees of freedom are provided in the following description.

Firstly, it is important to determine the characteristics of the light interacting with each optic. If the light is converging, diverging, collimated, or a focused spot, different effects will result from different components. In the example OCT system, the beams were typically focused or collimated light.

The effect each individual component will have on the light path is then determined. Light incident on a flat mirror, a lens, a curved mirror, or other optical surfaces will all behave differently. The initial characteristics of the light at that surface will also matter. For systems characterized primarily by simple surfaces (such as flat mirrors, circularly symmetric lenses operating on collimated light, and similar), a geometric analysis is typically sufficient. When more complex optics are used, it may be important to model the beam propagation using simulation software such as ZEMAX® (especially if the effect of one optic is expected to cause significant changes to the operation of another optic). Some specific examples are briefly provided in the forthcoming paragraphs.

A flat mirror operating on collimated light is one of the simpler optics to consider. Light reflecting off a flat mirror is reflected about the normal of the mirror surface. For collimated light, all the beams are travelling in the same direction and produce the same reflection. Four degrees of freedom (rotation about the normal, translation in two orthogonal dimensions perpendicular to the normal, and translation along the normal) have no effect on the direction of the normal—movement in these directions will not affect the reflection angle.

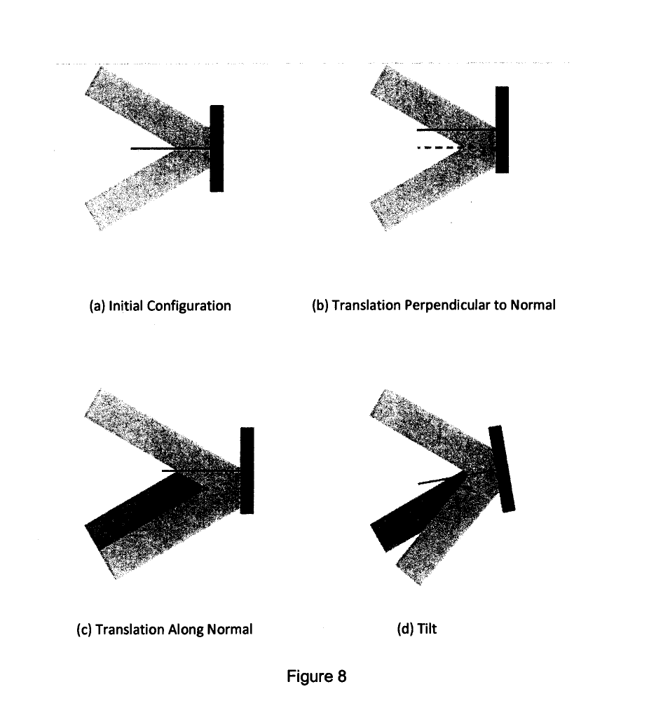

The two remaining degrees of freedom cause a rotation of the normal, which leads to a different reflection angle of the beams. In addition, translation along the normal, while not affecting the direction of reflection, will change the incident point, potentially changing the path length and shear of the beam. With large movements, it is also possible for any degree of freedom other than rotation about the normal to cause the incident light to bypass the mirror. These effects are illustrated in FIG. 8.

A standard lens converts a collimated beam into a focused spot over a specific focal length and vice versa. In the ideal case, tilts in the collimated beam are converted to positional shifts in the focal plane while shears simply tilt the cone angle. In reverse, a positional shift in the focused spot causes a tilt in the collimated beam while the incoming angle of the light from the spot determines the location of collimated beam (i.e., its shear).

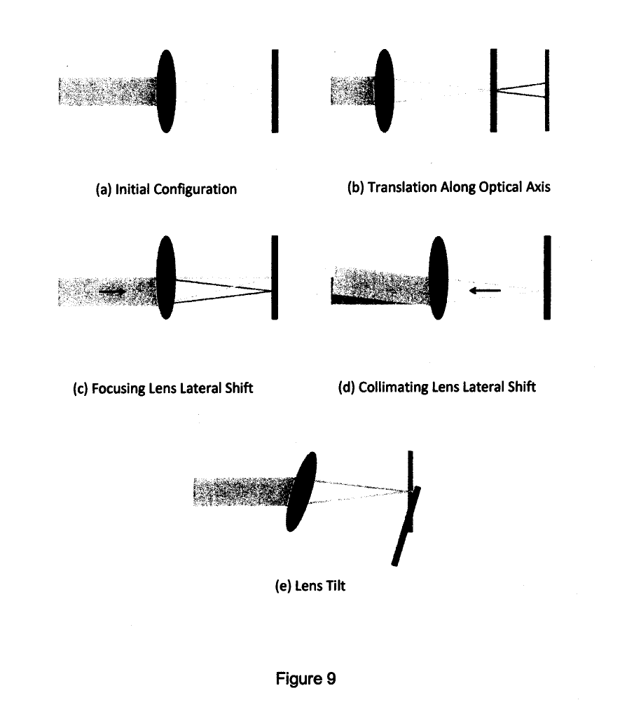

If the lens rotates about the optical axis, nothing changes. If the lens shears along the optical axis, the focal point of the lens shifts. If it shears perpendicular to this axis, the effect will vary depending on the direction of light propagation—if the lens is collimating light then a tilt will be seen in the collimated beam, while if the lens is focusing collimated light then the light will focus to a different point. If the lens tilts, this will rotate the focal plane and change the focused light position. As with the mirror, large enough shifts or rotations can cause the beam to completely miss the lens but this is an extreme case. These effects are illustrated in FIG. 9.

A single mode fiber can be approximated as a point source emitting light in a specified cone. If this light is to be collimated by a lens, the effects are related to those caused by a lens. If the position of the fiber changes on the focal plane of the lens, a tilt will be generated in the collimated beam leaving the lens. If the exit of the fiber leaves the focal plane of the lens, a defocus is caused. If the exit cone of light from the fiber tilts, shear will be generated in the collimated beam.

A corner-cube retroreflector consists of three reflective surfaces forming a shape similar to the corner of a room where ceiling or floor meets two side walls. This optical layout has several beneficial properties, a primary one being strong tilt insensitivity—a beam entering the retroreflector exits with the same tilt as the incoming beam, as if bouncing off a flat mirror with a normal closely aligned to the optical axis. Unlike a flat mirror, though, any beam shear (or, equivalently, a shear in the retroreflector) is flipped about the center of the retroreflector. This effect has both advantages and disadvantages—while the sensitivity to shear can cause beam position errors, it can also be used to accurately cause an offset in beam position with no change in tilt.

Similar analyses can be performed for other optical components. After identifying all the possible degrees of freedom, they can be reduced to identify those that have a net effect of the system, and an alignment controls can be provided for the reduced set of dominant degree of freedom. This process is discussed in further depth below.

After having identified the effect of errors in each optical component, the next step in the method is the determination of the required controls to correct for these errors. First, the dominant degrees of freedom are isolated as those that produce misalignment errors that have a substantial and/or important impact on system performance. Misalignments may generate problems due to beam or tilt offsets at the final detector (where an error changes the detected signal) or at an intermediate location such as a pinhole plane (where an error can cause the light to no longer propagate through the system). Such locations correspond to positions at which the system alignment is to be monitored in order to provide feedback for the correction of errors. It is also important to identify which optical components and/or subsystems contribute to detectable errors at each relevant location. These optical components are those at which corrections may need to be performed to correct the errors.

After having identified where dominant errors can be corrected, the dominant degrees of freedom that generate the errors are reduced (if possible) into a smaller number of dominant degrees of freedom. For example, a tilt caused by a mirror can be corrected by a tilt in the beam hitting the mirror. This is true even for multiple mirrors in series, allowing a single tilt correction to handle many different tilt contributions.

It is also important to note, at this point, that if the light returns along the same path it originally followed, many misalignments will be self-corrected. This can be seen, for example, by considering a beam that reflects off the same mirror twice from opposite directions—when the beam first hits the mirror any error term is added in but, on the return trip, the reverse error is added (effectively subtracting out the original error). By identifying locations where this occurs, significant reduction in the number of required control surfaces can be achieved.

Once all possible consolidations have been identified and a reduced set of dominant degrees of freedom are obtained, one is left with a minimal number of necessary correction axes. Monitoring and control apparatus may then be implemented to measure and correct errors related to these axes. While the implementation choice can vary for different systems, the apparatus and algorithms similar to those described above for the OCT system are suitable for many different system configurations, and those skilled in the art will appreciate that the systems and methods can be readily extended to other interferometric systems.

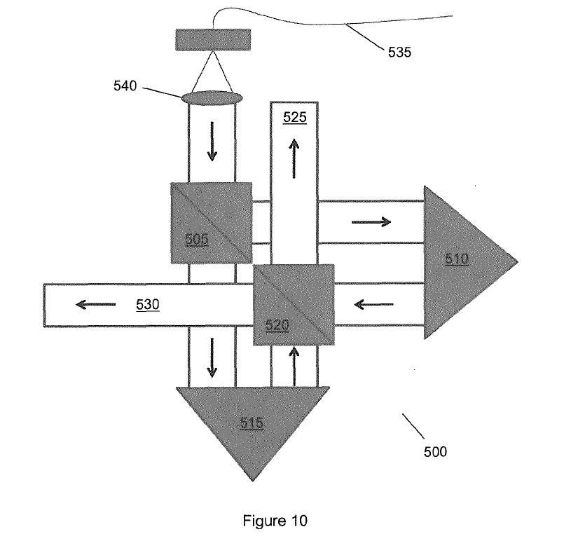

Referring now to FIG. 10, a simplified example system is now provided to illustrate the application of the preceding generic design methods, and to provide a prescription of how the design method can be applied to other interferometric systems.

FIG. 10 shows an offset beam interferometer 500, which may be employed in a Fourier Transform Spectrometer (FTS) or other interferometric optical metrology system. The offset layout allows easy access to the complementary outputs of the interferometer, collecting additional signal over a single output design. Collimated light enters the interferometer (in this case, collimating the output of a fiber 535 with a lens 540) and is split by beam splitter cube 505. The beam splitter cube 505 acts as a mirror for half the light (sending light towards Retroreflector 510) and transmits the other half of the light. Two corner-cube retroreflectors (510 and 515) are employed to offset the beams and return them to a second beam splitter cube 520. Half the light from retroreflector 515 passes through the second beam splitter cube 520 and joins half the light from retroreflector 510, which is reflected from beam splitter cube 520 to form collimated output beam 525.

The other half of light from retroreflector 515 reflects off beam splitter cube 520 and joins with half the light from retroreflector 510 that is transmitting through beam splitting cube 520 to form collimated output beam 530. Complementary interference effects due to phase shifts caused by different path lengths for the two arms of the interferometer provide the signals in outputs 525 and 530.

Examining the system according to the method outlined above, one notes that there are six different optics that can have an effect on the alignment: the fiber 535, the collimating lens 540, the two beam splitter cubes 505 and 520, and the two retroreflectors 510 and 515.

Treating the beam splitter cubes 505 and 520 like mirrors for the reflective path and ignoring them for the transmissive path, we can use the preceding method to determine the effect of the various optical components on the system. In addition, one can readily identify the primary alignment points as being located at outputs 525 and 530.

Considering output 530, there is a focus effect from the fiber/collimating lens pair 535 and 540, an overall tilt and shear from the same, a tilt in one beam from beam splitter cube 505 and a tilt in the other beam from beam splitter cube 520, and a shear in one beam from retroreflector 510 and in the other beam from retroreflector 515.

At output 525, there exists a focus effect from the fiber/collimating lens pair 535 and 540, an overall tilt and shear from the same, a tilt in one beam from both beam splitter cubes 505 and 520, and a shear in one beam from retroreflector 515 and in the other beam from retroreflector 510.

If an analysis of the consequences of the effects of misalignments on system performance indicates that collimation is a significant factor, the system has only one place to affect the collimation, and corrections made here propagate through the rest of the system equally. For the rest of the system, it may be important to account for the following: (1) that the two beams forming output 530 have the same tilt, (2) the two beams at output 530 have the same shear, (3) the two beams at output 525 have the same tilt, (4) the two beams at output 525 have the same shear, (5) outputs 525 and 530 have appropriate overall tilts, and (6) outputs 525 and 530 have appropriate overall shears.

In order for criterion (1) to hold, beam splitter cube 505 and beam splitter cube 520 should have the same tilt—if this is not the case, the beams reflecting from beam splitter cube 505 and beam splitter cube 525 would each have a different induced tilt after having started with the same tilt before entering beam splitter cube. The use of a single large beam splitter cube can mitigate this effect, although this can increase the amount of dispersive and absorptive glass in the system and does not allow for corrections of any imperfections in the retroreflectors or splitting surface. Motorizing the tip and tilt of one beam splitter cube provides the necessary alignment freedom to maintain this axis. A tilt monitoring system (similar to the one used to monitor pinhole alignment in the OCT system described above) can provide the necessary feedback for this axis.

For criterion (2) to hold, the beams should be coincident at beam splitter cube 520 (if the two beams are coincident and have the same tilt, they will stay coincident as they travel further). Motorizing either of retroreflectors 510 and 515 can correct for any relative offset in the two beams and a shear monitoring system similar to that in the OCT system disclosed above can measure this offset.

It is noted that criterion (3) holds automatically if criterion (1) holds. The beam that passes through both beam splitter cubes 505 and 520 (or one beam splitter twice) accrues no tilt and the beam reflecting twice will cancel out any tilt on the second reflection. A similar relationship is true between criteria (2) and (4)—if the beams are coincident with the same tilt at the beam splitter, they will follow the same path leaving in both directions. This allows the same components to be employed to ensure that both arms overlap in both outputs.

While it can now be ensured that both arms of the interferometer will be overlapping at both outputs 525 and 530, the overall tilt (criterion 5) and shear (criterion 6) of these outputs may not be appropriate. Overall tilt can be easily added using the fiber position or collimating lens position, but these will adjust the two outputs simultaneously in opposite directions (because of the number of reflections seen by the two outputs). Also motorizing the tilt of the beam splitters allows for individual adjustment of the tilt of output 530—if output 525 is corrected using the fiber position and then the overall beam splitter tilt is adjusted to correct output 530, it can be ensured that both outputs have their own correct tilt.

Adjusting both retroreflectors 510 and 515 allows for a shear correction, again simultaneously adjusting both outputs 525 and 530 in opposite directions. A shear of a beam splitter cube can allow separation of the control of the two outputs horizontally but not vertically. If additional optical surfaces are acceptable (or already present) and the outputs need to be adjusted individually, a motorized fold mirror (for tilt only) or dogleg (for tilt and shear) can be placed after beam recombination (for one or both outputs. As above, similar tilt and shear sensors to those used in the OCT system can monitor these parameters for similar other systems.

The specifics of the automation of this system will depend upon the desired goals of the system. In some embodiments, it is important for the relative tilt and shear of the two beams to be corrected—without this, the system will often not act as an interferometer. While not required for all systems (for example, if a large photodiode is used to measure the interference of both outputs), the overall tilt and shear will usually be corrected after correcting any relative effects—it is generally much easier to misconstrue a relative offset as an overall tilt or shear than a relative tilt or shear. Isolating as many degrees of freedom as possible greatly simplifies the design of any specific control system to correct for errors. While it is to be understood that there is no particular requirement for a specific order of correction, those skilled in the art may find it useful to choose an order that simplifies the required monitoring and control systems.

This simplified example has shown how the design of an alignment system according to the method disclosed above can be adapted to the specific optical layout of the overall system.

In addition to supporting the alignment protocols and methods disclosed above, the alignment apparatus can be employed to provide several other advantages. As described above, a significant amount of system alignment control can be accessed directly through the computer. Specifically, while a computing system such as a personal computer may be employed to automate the aforementioned alignment algorithm, such a computing system may further comprise a user interface allowing manual intervention.

In one embodiment, an operator can manually control system to perform the alignment method. The operator may control the system through a user interface. In another embodiment, the system may perform automated alignment according to the methods described above, and the user interface may allow the operator to remotely access the alignment system, enabling the operator to interrupt the automated method and manually correct an error without requiring an on-site visit. In another embodiment, the computing system provides diagnostic information to an operator (for example, over a remote internet connection), which allows the operator to access information relating to the state of the system, its history, and/or any error conditions or warnings, which could be useful to monitor the system and to aid in planning an on-site visit.

In another embodiment, the information obtained from the imaging cameras is provided to a user for direct visual monitoring of the system state and/or for direct monitoring of the sample under examination. Specifically, the sample focus plane is reimaged onto the pinhole plane, which effectively allows real-time visual sample analysis and monitoring without interrupting a measurement or altering the system alignment. Such sample analysis allows visualization of the light returning from the sample and analysis of features such as the sample focus, basic structural features in the sample, and the intensity of light returned from the sample.

The following examples are presented to enable those skilled in the art to understand and to practice embodiments of the present disclosure. They should not be considered as a limitation on the scope of the present embodiments, but merely as being illustrative and representative thereof.

### EXAMPLES

### Example 1

### Alignment Limits

Generally speaking, the example alignment system disclosed above corrects for small and moderate alignment errors. This following discussion quantifies the parameter space within which alignment is expected to be maintained, based on the specific equipment quoted above. It is to be understood that different system architectures, and different choices in the specific optical and mechanical elements employed, will result in different system alignment limits.

The tilt sensor has a field of view of about 3000×2000 arcseconds. The pinhole size is about 27.5 arcseconds in diameter with a diffraction limited spot size diameter of about 20.4 arcseconds. The camera pixel size is about 4.1 arcseconds per pixel and the centroiding precision is better than 0.1 pixels (0.41 arcseconds). In the spot plane, a movement of 1 arcsecond corresponds to 0.36 μm. A 1° C. temperature change near room temperature corresponds to about 0.88 μm (2.44 arcseconds) in a 1.5″ (25.4 mm) tall aluminum mount. A 1″ (25.4 mm) diameter mirror would involve about 0.05 μm positional offset between opposite edges for a 1 arcsecond tilt. It is expected that a significant performance degradation in the system would result from a several degree temperature change, however, it should be possible to compensate for tilt errors resulting from even larger temperature changes (for example, 10's of degrees Celsius).

The shear sensor has a field of view of about 37.6×24 mm, and the pupil diameter is about 21 mm. Each pixel in the field of view corresponds to about 50 μm. For efficiency, the pupil position measurement only determines offsets at the single pixel level, or 0.2% of the pupil diameter. This axis is less sensitive than the tilt axis, with a sizable portion of the error being directly due to tilt changes—a 10 arcsecond beam tilt causes a 0.1 mm shift over a 1 m path. Pupil shifts that stay fully on the camera (˜1.5 mm in the smallest direction) can be readily identified and it is possible to determine the an appropriate direction of movement for significantly larger offsets—the pupils will still be on the detector for shifts of over 20 mm. Accordingly, the limitations on this camera should not restrict the useable range of the system past what the tilt sensor requires.

### Example 2

### Sample Code

The computer code provided herein may be employed to measure offsets for the alignment system. While the code has been simplified for clarity and brevity (for example, removing interface specific functions and hardware error monitoring code), the core algorithms are included herein for heuristic support.

### Centroiding Code

Several algorithms rely on locating the positions of spots and circles in the focal plane. The following centroiding algorithms have been employed to obtain these positions. The choice between the two centroiding algorithms given depends upon the target being imaged—for clean, sharply defined spots, the weighted centroiding provides higher accuracy while the threshold centroiding performs better with large, diffuse, speckled returns from highly scattering samples.

### Threshold Centroiding

The following centroiding method computes the average position of all pixels above a specified threshold. This method is most useful when a large spread of returning light is expected without a clearly focused spot profile, such as when imaging a highly scattering sample.

```
/** Return the average position of the points above a given threshold in
* an image. If all points are below the threshold, return [−1, −1].
*
* @param img The image to centroid.
* @param thresh The threshold.
* @return The average position of pixels above the threshold.
*/
public Point2D thresholdCentroid(BufferedImage img, int thresh)
{
  //initialize centroiding variables
  double cenx = 0;
  double ceny = 0;
  int counted = 0;
  //determine the image size
  int width = img.getWidth( );
  int height = img.getHeight( );
  //extract the image data into an array
  int imgdata[ ] = img.getData( ).getSamples(0, 0, width, height, 0,
```

(int[ ])null);

```
  //loop over the pixels in the image
  for(int i=0; i < height; i++)
  {
    for(int j=0; j < width; j++)
    {
      //if a pixel is above the threshold
      if(imgdata[i*width + j] >= thresh)
      {
        //increment the pixel count
        counted++;
        //add the pixel position to the averaging variables
        cenx += j;
        ceny += i;
      }
    }
  }
  //if we found any pixels above the threshold
  if(counted > 0)
  {
    //convert the sums to an average position
    cenx /= counted;
    ceny /= counted;
  }
  //otherwise, return the error condition
  else
  {
    //if no points were above the threshold, return [−1,−1]
    cenx = −1;
    ceny = −1;
  }
  if(debug)
  {
    System.out.printIn(cenx+“ ”+ceny);
  }
  return new Point2D.Double(cenx, ceny);
}
```

### Weighted Centroiding

This centroiding method weights the centroided pixels by their intensity. Focused spots should have more intensity near the center of the spot and this accommodates that in the position measurement. This method also allows an offset term to ignore background noise or correct for a negative bias.

```
/** Return the average position of the points in an image, weighted by
* their intensity. Allows an offset that values are shifted by to
* affect weighting (values reduced below 0 become 0). Return [−1,−1]
* if all pixels are 0.
*
* @param img The image to centroid.
* @param offset The shift to apply to pixel values.
* @return The average position of pixels weighted by their intensity.
*/
public Point2D weightedCentroid(BufferedImage img, int offset)
{
  //initialize centroiding variables
  double cenx = 0;
  double ceny = 0;
  long weight = 0;
  //determine the image size
  int width = img.getWidth( );
  int height = img.getHeight( );
  //extract the image data into an array
  int imgdata[ ] = img.getData( ).getSamples(0, 0, width, height, 0,
```

(int[ ])null);

```
  //loop over the pixels in the image
  for(int i=0; i < height; i++)
  {
    for(int j=0; j < width; j++)
    {
      //remove the requested offset from the image
      int val = imgdata[i*width + j] − offset;
      //require pixel values to be positive (no negative photons)
      val = (val > 0)?val:0;
      //sum the total image counts used for centroiding
      weight += val;
      //sum the pixel positions appropriately weighted
      cenx += j*val;
      ceny += i*val;
    }
  }
  //if we found useful pixels
  if(weight > 0)
  {
    //convert the weighted sum to a weighted average
    cenx /= weight;
    ceny /= weight;
  }
  //otherwise, return the error condition
  else
  {
    //if the entire image has an intensity of 0, return [−1,−1]
    cenx = −1;
    ceny = −1;
  }
  if(debug)
  {
    System.out.println(cenx+“ ”+ceny);
  }
  return new Point2D.Double(cenx, ceny);
}
```

### Save Current Alignment Code

This section of code stores the current system alignment to allow the system to maintain the current alignment configuration. While best performed with good alignment, the system is designed to allow maintenance of any desired alignment configuration. To this end, additional code to obtain a good initial alignment state is included below. Note that error handling and interface specific code has been trimmed for brevity.

```
/** The store current alignment button was pressed. Store the necessary
* variables to maintain the current alignment.
*
*/
private void storeCurrentAlignmentButtonActionPerformed( )
{
  //store the configured threshold for tilt alignment
  int tiltCentroidThresh;
  try
  {
    //multiply by 256 to convert to 16 bit format of averaged images
    //instead of 8 bit original image format
    tiltCentroidThresh = Math.round(Float.parseFloat(
                    tiltThreshField.getText( ))*256);
  }//handle conversion exception here
  //store the configured threshold for shear alignment
  int shearCentroidThresh;
  try
  {
    //multiply by 256 to convert to 16 bit format of averaged images
    //instead of 8 bit original image format
    shearCentroidThresh = Math.round(Float.parseFloat(
                    shearThreshField.getText( ))*256);
  }//handle conversion exception here
  //store tilt alignment
  try
  {
    if(tiltcam == null)
    {
      throw new AlignmentException(“Null tilt camera.”);
    }
    //obtain an averaged image
    tiltBase = tiltcam.getAverageImage(ntilt);
    //subtract the background data
    tiltBaseBack = subtractImages(tiltBase, tiltback);
    //compute the current spot center
    tiltCenter = centroid(tiltBaseBack, tiltCentroidThresh);
  }//handle camera errors here
  //store shear alignment
  try
  {
    if(shearcam == null)
    {
      throw new AlignmentException(“Null shear camera.”);
    }
    //obtain an image of the reference arm
    blockSampleArm( );
    //obtain an averaged image
    referenceArmImage = shearcam.getAverageImage(nshear);
    //subtract the background data
    referenceArmImageBack = subtractImages(referenceArmImage,
                        shearback);
    //compute the current pupil center
    referenceArmCenter = centroid(referenceArmImageBack,
                    shearCentroidThresh);
    unblockSampleArm( );
    //obtain an image of the sample arm
    blockReferenceArm( );
    //obtain an averaged image
    sampleArmImage = shearcam.getAverageImage(nshear);
    //subtract the background data
    sampleArmImageBack = subtractImages(sampleArmImage,
    shearback);
    //compute the current pupil center
    sampleArmCenter = centroid(sampleArmImageBack,
                  shearCentroidThresh);
    unblockReferenceArm( );
  }//handle camera errors here
  //ensure that the reference and sample arms are not blocked.
  unblockReferenceArm( );
  unblockSampleArm( );
}
```

### Tilt Alignment Offset

This section of code computes the current offset from the desired alignment for the tilt monitoring system. Note that error handling and interface specific code has been trimmed for brevity.

```
/** The update tilt position button was pressed. Determine the tilt
* offset from the baseline position.
*
*/
private void updateTiltPositionButtonActionPerformed( )
{
  //store the threshold level desired
  int tiltCentroidThresh;
  try
  {
    //multiply by 256 to convert to 16 bit format of averaged images
    //instead of 8 bit original image format
    tiltCentroidThresh = Math.round(Float.parseFloat(
                    tiltThreshField.getText( ))*256);
  }//handle conversion exception here
  try
  {
    if(tiltcam == null)
    {
      throw new IDSException(“Null camera.”);
    }
    //obtain a new averaged image and subtract the background
    BufferedImage img = subtractImages(tiltcam.getAverageImage(ntilt),
                    tiltback);
    //compute the current centroid
    Point2D imgCen = centroid(img, tiltCentroidThresh);
    //throw an error if no centroid could be computed
    if(imgCen.getX( ) == −1 && imgCen.getY( ) == −1)
    {
      tiltOffset = null;
      throw new AlignmentException(“Unable to computer tilt offset.”);
    }
    //compute the tilt offset amount from the stored position
    //store the offset in the appropriate variable
    tiltOffset = new Point2D.Double(tiltCenter.getX( )−imgCen.getX( ),
        tiltCenter.getY( )−imgCen.getY( ));
  }//handle errors here
}
```

### Shear Alignment Offset

This section of code computes the current offset from the desired alignment for the shear monitoring system. Note that error handling and interface specific code has been trimmed for brevity.

```
/** The update shear position button was pressed. Determine the shear
* offset from the baseline position.
*
*/
private void updateShearPositionButtonActionPerformed( )
{
  try
  {
    if(shearcam == null)
    {
      throw new IDSException(“Null camera.”);
    }
    //obtain a new averaged image and subtract the background
    BufferedImage img = subtractImages(shearcam.getAverageImage(
                      nshear), shearback);
    //compute the shear offset
    int imgOff[ ] = fitOffset(img, referenceArmImageBack,
                    sampleArmImageBack);
    //throw an error if no offset could be computed
    if(imgOff == null)
    {
      shearOffset = null;
      throw new AlignmentException(“Unable to compute shear
      offset.”);
    }
    //store the offset into the appropriate variable
    shearOffset = new Point2D.Double(−imgOff[0], −imgOff[1]);
  }//handle errors here
}
```

The following function is called to compute the actual offset above.

```
/** Compute the offset between the combined image and the reference
* and sample images.
*
* @param img The combined image to compare against.
* @param ref The reference arm image to shift.
* @param sam The sample arm image to shift.
* @return An array of 4 integers containing the x and y shift for the
* reference and sample images. If any of the original images are
* null, returns null.
*/
public int[ ] fitOffset(BufferedImage img, BufferedImage ref,
            BufferedImage sam)
{
  //if any of the images are null, return null
  if(img == null || ref == null || sam == null)
  {
    return null;
  }
  //obtain the width and height of the base image
  //assume all 3 are the same
  int width = img.getWidth( );
  int height = img.getHeight( );
  //fit the reference and sample images to the combined image
  int refx = 0;
  int refy = 0;
  int samx = 0;
  int samy = 0;
  //total number of steps = 2*steps+1
  //this is the number of steps above and below 0
  //increasing this parameter increases the computation time
  //increasing this parameter improves resistance to non-smooth
  //data
  int steps = 1;
  //the total range (both + and −) over which to look, in pixels
  int range = 64;
  //initialize the error measurement to a large value
  int minval = Integer.MAX_VALUE;
  //get the image rasters
  //these contain the image data in an easily usable format
  int[ ] curras = img.getData( ).getPixels(0, 0, width, height,
                  (int[ ])null);
  int[ ] refras = ref.getData( ).getPixels(0, 0, width, height,
                  (int[ ])null);
  int[ ] samras = sam.getData( ).getPixels(0, 0, width, height,
                  (int[ ])null);
  //loop until we have one pixel steps
  //compute the shift in pixels from the reference and sample images
  //to the combined image
  for(;range >= 1;range /= (2*steps))
  {
    //compute the starting and ending shifts for each image
    //these determine the search range at each iteration
    int mini = refx − range;
    int maxi = refx + range;
    int minj = refy − range;
    int maxj = refy + range;
    int mink = samx − range;
    int maxk = samx + range;
    int minl = samy − range;
    int maxl = samy + range;
    //loop through the various image shifts
    for(int i=mini;i <= maxi;i += range/steps)
    {
      for(int j=minj;j <= maxj;j += range/steps)
      {
        for(int k=mink;k <= maxk;k += range/steps)
        {
          for(int l=minl;l <= maxl;l += range/steps)
          {
            int tmp = 0;
            for(int n=0;n<height;n++)
            {
              for(int m=0;m<width;m++)
              {
                //compute the shifted difference
                //use m+i+width and similar to ensure
                //a positive remainder
                //wraparound happens in this setup
                //since the images should be dark
                //at most edges, this doesn't cause
                //problems
                tmp += Math.abs(curras[m + n*width] −
                  refras[((m+i+width) % width) +
                  ((n+j+height) % height)*width] −
                  samras[((m+k+width) % width) +
                  ((n+l+height) % height)*width]);
              }
            }
            //if we've found a reduced residual
            if(tmp < minval)
            {
              //update the new best shift parameters
              minval = tmp;
              refx = i;
              refy = j;
              samx = k;
              samy = l;
            }
          }
        }
      }
    }
  }
  //store the best shift parameters
  int toReturn[ ] = new int[4];
  toReturn[0] = refx;
  toReturn[1] = refy;
  toReturn[2] = samx;
  toReturn[3] = samy;
  if(debug)
  {
    System.out.println(refx+“ ”+refy+“ ”+samx+“ ”+samy);
  }
  return toReturn;
}
```

### Correction Code

The code in this section is used to calibrate the system and convert measured offsets to physical corrections. While the code has been simplified for clarity and brevity (for example, removing interface specific functions and hardware error monitoring code), the core algorithms should be apparent.

### Motor Calibration

The following code is employed to calibrate the tilt correction motors to the tilt monitoring camera. Similar code is used for calibrating all the motors. As the required alignment corrections are calculated in pixel space, this calibration allows for the determination of the required motor motions for different alignment offsets. Error handling and initialization code is omitted for brevity.

```
//obtain a 0 point image.
BufferedImage imgOri = subtractImages(tiltcam.getAverageImage(ntilt),
tiltback);
//move in the positive X direction and take an image.
picocontroller.forward(motor1, stepsize);
BufferedImage f1Img = subtractImages(tiltcam.getAverageImage(ntilt),
tiltback);
//move in the negative X direction and take an image.
picocontroller.reverse(motor1, stepsize);
BufferedImage r1Img = subtractImages(tiltcam.getAverageImage(ntilt),
tiltback);
//move in the positive Y direction and take an image.
picocontroller.forward(motor2, stepsize);
BufferedImage f2Img = subtractImages(tiltcam.getAverageImage(ntilt),
tiltback);
//move in the negative Y direction and take an image.
picocontroller.reverse(motor2, stepsize);
BufferedImage r2Img = subtractImages(tiltcam.getAverageImage(ntilt),
tiltback);
//show the last image on screen
tiltPanel.changeImage(r2Img);
//compute the spot centers in each image
Point2D cenOri = centroid(imgOri, tiltCentroidThresh);
Point2D f1 = centroid(f1Img, tiltCentroidThresh);
Point2D r1 = centroid(r1Img, tiltCentroidThresh);
Point2D f2 = centroid(f2Img, tiltCentroidThresh);
Point2D r2 = centroid(r2Img, tiltCentroidThresh);
//convert the motions to appropriate parameters
//units are pixels per motor step
double m1Fx = (f1.getX( ) − cenOri.getX( ))/stepsize;
double m1Fy = (f1.getY( ) − cenOri.getY( ))/stepsize;
double m1Rx = −(r1.getX( ) − f1.getX( ))/stepsize;
double m1Ry = −(r1.getY( ) − f1.getY( ))/stepsize;
double m2Fx = (f2.getX( ) − r1.getX( ))/stepsize;
double m2Fy = (f2.getY( ) − r1.getY( ))/stepsize;
double m2Rx = −(r2.getX( ) − f2.getX( ))/stepsize;
double m2Ry = −(r2.getY( ) − f2.getY( ))/stepsize;
//update the appropriate fields
if(Math.abs(m1Fx) > Math.abs(m1Fy))
{
  //motor one moves more in the X direction than Y
  if(m1Fx > 0)
  {
    //motor one moves positive pixels for a forward move
    tilt1XField.setText(“”+m1Fx);
    tilt1XNField.setText(“”+m1Rx);
    tilt1YField.setText(“”+m1Fy);
    tilt1YNField.setText(“”+m1Ry);
  }else
  {
    //motor one moves negative pixels for a forward move
    tilt1XField.setText(“”+−m1Rx);
    tilt1XNField.setText(“”+−m1Fx);
    tilt1YField.setText(“”+−m1Ry);
    tilt1YNField.setText(“”+−m1Fy);
  }
}else
{
  //motor one moves more in the Y direction than X
  if(m1Fy > 0)
  {
    //motor one moves positive pixels for a forward move
    tilt1XField.setText(“”+m1Fx);
    tilt1XNField.setText(“”+m1Rx);
    tilt1YField.setText(“”+m1Fy);
    tilt1YNField.setText(“”+m1Ry);
  }else
  {
    //motor one moves negative pixels for a forward move
    tilt1XField.setText(“”+−m1Rx);
    tilt1XNField.setText(“”+−m1Fx);
    tilt1YField.setText(“”+−m1Ry);
    tilt1YNField.setText(“”+−m1Fy);
  }
}
if(Math.abs(m2Fx) > Math.abs(m2Fy))
{
  //motor two moves more in the X direction than Y
  if(m2Fx > 0)
  {
    //motor two moves positive pixels for a forward move
    tilt2XField.setText(“”+m2Fx);
    tilt2XNField.setText(“”+m2Rx);
    tilt2YField.setText(“”+m2Fy);
    tilt2YNField.setText(“”+m2Ry);
  }else
  {
    //motor two moves negative pixels for a forward move
    tilt2XField.setText(“”+−m2Rx);
    tilt2XNField.setText(“”+−m2Fx);
    tilt2YField.setText(“”+−m2Ry);
    tilt2YNField.setText(“”+−m2Fy);
  }
}else
{
  //motor two moves more in the Y direction than X
  if(m2Fy > 0)
  {
    //motor two moves positive pixels for a forward move
    tilt2XField.setText(“”+m2Fx);
    tilt2XNField.setText(“”+m2Rx);
    tilt2YField.setText(“”+m2Fy);
    tilt2YNField.setText(“”+m2Ry);
  }else
  {
    //motor two moves negative pixels for a forward move
    tilt2XField.setText(“”+−m2Rx);
    tilt2XNField.setText(“”+−m2Fx);
    tilt2YField.setText(“”+−m2Ry);
    tilt2YNField.setText(“”+−m2Fy);
  }
}
//correct for any residual offset in positioning
moveTilt(cenOri.getX( ) − r2.getX( ), cenOri.getY( ) − r2.getY( ));
```

### Alignment Calibration Code

This is a sample of the algorithm used to calibrate the alignment system to improve alignment capabilities after significant system drifts. Similar code is used for other axes—primarily using different motor axes and parameter variables—and omitted for brevity.

```
/** Maximize the throughput landing on the detector using the tilt
* control. No beams are unblocked or blocked--perform this first if
* you wish to align using only a specific arm.
*
* @param moveTilt The initial step size for maximum searching of the
* tilt axis.
* @param tiltThresh Stop iterating when the requested movement size
* is smaller than this.
* @param reductionFactor The movement size is divided by this factor
* every iteration. Must be greater than one.
*/
public void tweakTiltAlignment(double moveTilt, double tiltThresh,
    double reductionFactor) throws AlignmentException
{
  if(reductionFactor <= 1)
  {
    throw new AlignmentException(“Reduction factor must be ” +
                “greater than 1: ”+reductionFactor);
  }
  //get the initial flux value
  double lastFlux = getFlux( );
  double curFlux;
  boolean direction = false;
  boolean swapped = false;
//loop until we're moving less than our threshold
while(Math.abs(moveTilt) >= tiltThresh)
{
  //move a little in one direction
  if(direction)
  {
    moveTilt(moveTilt, 0);
  }else
  {
    moveTilt(0, moveTilt);
  }
  curFlux = getFlux( );
  //if we've started going down in intensity
  if(curFlux < lastFlux)
  {
    //if we haven't already swapped directions for this axis
    if(!swapped)
    {
      //swap directions
      moveTilt = −moveTilt;
        swapped = true;
      }else
      {
        //reset the swapped variable
        swapped = false;
        //if we've swapped axes at this move size,
        //reduce the move size
        if(direction)
        {
          moveTilt = moveTilt / reductionFactor;
        }
        //swap the axes
        direction = !direction;
      }
    }
    lastFlux = curFlux;
  }
}
```

### Pixel Offset to Motor Command Conversion

The alignment monitoring code measures offsets from the desired alignment in pixel space. The motor calibration provides conversion parameters from pixel space to motor movements. The code below shows the conversion process for the tilt system. Directly sending the converted commands to the motor (with or without a damping factor) is sufficient to maintain system alignment. Similar code, simply changing the appropriate variables, provides the same functionality for other axes. Interface specific code (such as confirming moves with the user) is omitted for brevity.

```
/** Move the motor controlling the tilt.
*
* @param x The number of pixels to shift horizontally by.
* @param y The number of pixels to shift vertically by.
* @throws AlignmentException If there is an error controlling the
* motors.
* @return Returns the number of motor counts moved by motor 1 and
* motor 2.
*/
public Point2D moveTilt(double x, double y) throws AlignmentException
{
  //variables to store motor calibration data
  double x1;
  double y1;
  double x2;
  double y2;
  //load the motor calibration data from the interface
try
{
  if(x >= 0)
  {
    //use the positive movement X fields
    x1 = Double.parseDouble(tilt1XField.getText( ));
    x2 = Double.parseDouble(tilt2XField.getText( ));
  }else
  {
    //use the negative movement X fields
    x1 = Double.parseDouble(tilt1XNField.getText( ));
    x2 = Double.parseDouble(tilt2XNField.getText( ));
  }
  if(y >= 0)
  {
    //use the positive movement Y fields
    y1 = Double.parseDouble(tilt1YField.getText( ));
    y2 = Double.parseDouble(tilt2YField.getText( ));
  }else
  {
    //use the negative movement Y fields
    y1 = Double.parseDouble(tilt1YNField.getText( ));
    y2 = Double.parseDouble(tilt2YNField.getText( ));
  }
}catch(NumberFormatException ex)
{
  //error parsing the calibration data
  throw new AlignmentException(ex);
}
//these are the motors we wish to control for the tilt control
String motor1 = tiltMotor1IDField.getText( );
String motor2 = tiltMotor2IDField.getText( );
//calculate the amount to move each motor to get to the desired
//position
//n * x1 + m * x2 = x
//n * y1 + m * y2 = y
//two equations with two unknowns
//we assume that the motors are mostly orthogonal and mostly aligned
//with the image axes and so the following solutions should be stable:
//n = (x − y*x2/y2)/(x1 − y1*x2/y2) -- bad when y2->0
//n = (y − x*y2/x2)/(y1 − x1*y2/x2) -- bad when x2->0
//m = (x − n*x1)/x2 -- bad when x2->0
//m = (y − n*y1)/y2 -- bad when y2->0
//final movement will need to be rounded to an integer number of
//pico steps. Our motors can only move discrete counts.
double n;
double m;
//determine which set of equations to use
if(Math.abs(x2) > Math.abs(y2))
{
  //x2 is less likely to be close to 0
  n = (y − x*y2/x2)/(y1 − x1*y2/x2);
  m = (x − n*x1)/x2;
}else
{
  //y2 is less likely to be close to 0
  n = (x − y*x2/y2)/(x1 − y1*x2/y2);
  m = (y − n*y1)/y2;
}
//round the amount to use each motor
int motor1move = (int)Math.round(n);
int motor2move = (int)Math.round(m);
try
{
    //forward with a negative value is equivalent to reverse
    //no need to check direction before sending the command.
    picocontroller.forward(motor1, motor1move);
    picocontroller.forward(motor2, motor2move);
    }catch(Exception ex)
  {
    throw new AlignmentException(ex);
  }
  //return the amount each motor was moved
  return new Point2D.Float(motor1move, motor2move);
}
```

### Reduction Code

Included herein are samples of the code used to produce images from OCT data. This code is designed for interactive analysis to help debug system operations.

### Initial Processing Code

This code takes data (already loaded) and extracts the sinusoidal interferograms that contain the spatial information for the images.

```
;identify the pixels to use
suse = 0
euse = 2047
;optionally isolate a subset of the date by uncommenting this
;adjust the selection variables as necessary
;array format =
;dimension 1 selects individual b-scans loaded
;dimension 2 selects spectrometer pixels
;dimension 3 selects a-scan repetitions
;dimension 4 selects different a-scan positions
;data = data[*,*,0,*]
;obtain the number of dimensions of each axis of data
sd = size(data)
;ignore specific data if needed by artificially fixing a dimension size
;sd[3] = 2
;create an array to store the processed data
data_avg = dblarr(sd[4], sd[2])
;loop through the different a-scan positions in the data set
for i=0,sd[4]−1 do begin
  ;select the appropriate averaging method
  if(sd[3] gt 1) then begin
    ;if we've chosen to average multiple b-scan repetitions
    data_avg[i,*] = reform(total(total(data[*,*,*,i],3),1))
  endif else begin
    ;only average a-scan repetitions
    data_avg[i,*] = reform(total(data[*,*,0,i],1))
  endelse
endfor
;normalize the averaged data to a single scan
data_avg = data_avg / double(sd[1]*sd[3])
;compute the average sample spectrum
samp = dblarr(n_elements(reference))
for i=0,n_elements(reference)−1 do begin
  samp[i] = mean(data_avg[*,i] − reference[i])
endfor
;normalize the data spectrum by some combination of the sample and
;reference spectra
;choose the method by uncommenting the appropriate lines
data_norm = data_avg
for i=0,sd[4]−1 do begin
  ;only subtract off the reference
  ;data_norm[i,*] = (data_avg[i,*] − reference)
;subtract off the reference, but first normalize the reference
;amplitude by the mean signal amplitude
;data_norm[i,*] = (data_avg[i,*] − mean(data_avg[i,*]/
reference)*reference)
;compute the relative intensity offset between the mean sample
;spectrum and the reference subtracted data
;sampamp = mean(data_norm[i,*]/samp)
;subtract a rescaled copy of the average sample spectrum from the data
;data_norm[i,*] = (data_norm[i,*] − sampamp*samp)
;normalize the interferogram by the square root of the sample power
;times the reference power
;data_norm[i,*] = data_norm[i,*]/sqrt(sampamp*samp*reference)
;if we end up dividing by 0, stop the code and ask for user input
;if((where(sampamp*samp*reference le 0))[0] ne −1) then stop
;process with sampleonly data
;this is sample data actually measured for different points in the
;sample
;subtract off the reference and sample value at each sample point
  ;data_norm[i,*] = (data_avg[i,*] − sample[i,*] − reference)
  ;fit a low order polynomial to the data to correct residual low
  ;frequency noise
  zz = poly_fit(lindgen(n_elements(data_norm[i,*])),data_norm[i,*],
  3,yfit=yfit)
  ;data_norm[i,*] = data_norm[i,*] − yfit
  ;ignore anything uncommented above and remove reference signal
  data_norm[i,*] = (data_avg[i,*] − reference)
  ;sample only removal
  ;data_norm[i,*] = (data_norm[i,*] − sample[i,*])
  ;normalize by sample*reference power
  ;data_norm[i,*] = data_norm[i,*]/sqrt(reference*sample[i,*])
endfor
;ensure the data has 0 mean so no residual FT power exists
data_use = dblarr(sd[4], euse−suse+1)
for i=0,sd[4]−1 do begin
  data_use[i,*] = data_norm[i,suse:euse]
  data_use[i,*] = data_use[i,*] − mean(data_use[i,*])
endfor
;indicate that no wavelength->wavenumber resampling has been done
resampled = 0
end
```

### Image Generation Code

This code takes the sinusoidal interferograms extracted from the data, performs resampling and basic dispersion correction, and then generates images.

```
;approximate the wavelength of each spectrometer pixel
pixlow = 0
wnlow = 1d/0.790d
pixhigh = 2047
wnhigh = 1d/0.890d
dwn = wnlow−wnhigh
dpix = pixhigh−pixlow
dwnpix = dwn/dpix
nuse = n_elements(data_use[0,*])
dum = dindgen(nuse)/(2*dwnpix*nuse)
;resample to wavenumber space
if(1) then begin
  if(resampled eq 0) then begin
    data_use_ori = data_use
    resampled = 1
    wavenumbers = dindgen(pixhigh−pixlow+1)/(pixhigh−pixlow)* $
              (wnhigh−wnlow)+wnlow
    lambdas_wn = 1/wavenumbers
    lambdas = dindgen(pixhigh−pixlow+1)/(pixhigh−pixlow)* $
            (1d/wnhigh − 1d/wnlow)+1d/wnlow
    for i=0,n_elements(data_use[*,0])−1 do begin
      data_use[i,*] = interpol(data_use[i,*], lambdas, lambdas_wn,
      /spline)
    endfor
  endif
endif
;initialize some storage variables
img = data_use*0
data_disp = data_use*0
img_disp = img*3
;optional dispersion parameters
;dist0 = −3d6
dist0 = 0d6
;change the dispersion linearly for each a-scan position
diststep = 0;2.25d6/49
;loop over all the a-scan positions
for i=0,n_elements(img[*,0])−1 do begin
  ;compute the FFT of the Hilbert transform of the data
  img[i,*] = (abs(fft(complex(data_use[i,*], hilbert(data_use[i,*], −1)))))
  ;apply some dispersion correction to the data before
  ;computing the FFT of the Hilbert transform
  data_disp[i,*] = dispersion_correction(data_use,i,dist0+
  diststep*fend,$
                    wavenumbers)
img_disp[i,*] = (abs(fft(complex(data_disp[i,*], $
                hilbert(data_disp[i,*], −1)))))
end
;compute the number of useful image pixels
nels = (euse−suse)/2
;convert the image to a log scale
img_sub = (alog10(img[*,0:nels] + min(img[*,0:nels]) + 1))
;create an 8 bit version of the image
img_res = round((img_sub+min(img_sub))/(max(img_sub)−
min(img_sub))*(2\hat{ }8))
;convert the dispersion corrected image to a log scale
img_disp_sub = alog10(img_disp[*,0:nels] + min(img_disp[*,
0:nels]) + 1)
;create an 8 bit version of the dispersion corrected image
img_disp_res = round((img_disp_sub+min(img_disp_sub))/ $
            (max(img_disp_sub)−min(img_disp_sub))*(2\hat{ }8))
;different display methods
;write the 8 bit non-dispersion corrected image to a tiff file
;write_tiff, samplename+‘_’+strtrim(fstart,2)+‘-’+$
        strtrim(fend,2)+‘.tiff’, img_res
;write the 8 bit dispersion corrected image to a tiff file
;write_tiff, samplename+‘_disp_’+strtrim(fstart,2)+‘-’+$
        strtrim(fend,2)+‘.tiff’, img_disp_res
;display the 8 bit non-dispersion corrected image in a window
;flip the image vertically
;iimage, reverse(img_res,2)
;display the 8 bit dispersion corrected image in a window
;flip the image vertically
;iimage, reverse(img_disp_res,2)
;display the 8 bit dispersion corrected image in a window
;iimage, img_disp_res
;display the non-dispersion corrected image in a window
;flip the image vertically
;iimage, reverse(img_sub,2)
;display the dispersion corrected image in a window
;flip the image vertically
;iimage, reverse(img_disp_sub,2)
;display the dispersion corrected image in a window
;flip the image vertically and horizontally
;iimage, reverse(reverse(img_disp_sub,2),1)
;display the dispersion corrected image in a window
;iimage, img_disp_sub
;display the dispersion corrected image in a window
;flip the image horizontally
iimage, reverse(img_disp_sub,1)
end
```

### Dispersion Compensation Code

Provided below is the code for the basic dispersion correction algorithm. A simplified form of the algorithm presented by Wojtkowski et al. is used.

```
;uses a simplified form of the algorithm from
;Wojtkowski et al. May 2004 (Optics Express Vol. 12 No. 11)
;and use Sellmeier's equation for refractive index
;from http://en.wikipedia.org/wiki/Sellmeier_equation
;assume BK7 glass
function dispersion_correction, data_use, id, dist, freq
;Sellmeier parameters
B1 = 1.03961212D
B2 = 0.231792344D
B3 = 1.01046945D
C1 = 6.00069867d−3 ;um\hat{ }2
C2 = 2.00179144d−2 ;um\hat{ }2
C3 = 1.03560653d2 ;um\hat{ }2
;Sellmeier's Equation:
;Beta(lambda) = eta(lambda)\hat{ }2
; = 1 + B1*lambda\hat{ }2/(lambda\hat{ }2 − C1)
; + B2*lambda\hat{ }2/(lambda\hat{ }2 − C2)
; + B3*lambda\hat{ }2/(lambda\hat{ }2 − C3)
;obtain the hilbert transform of the data
hil_data = complex(data_use[id,*], hilbert(data_use[id,*], −1))
;take the magnitude and phase
mag = abs(hil_data)
phase = atan(hil_data, /phase)
;compute the Sellmeier equation
beta = (1d + B1*(1/freq)\hat{ }2/((1/freq)\hat{ }2 − C1) $
      + B2*(1/freq)\hat{ }2/((1/freq)\hat{ }2 − C2) $
      + B3*(1/freq)\hat{ }2/((1/freq)\hat{ }2 − C3))
eta = sqrt(beta)
;first derivative
dbeta = (beta−shift(beta,1))/(freq−shift(freq,1))
;remove edge effect
dbeta[0] = dbeta[1]
;second derivative
d2beta = (dbeta−shift(dbeta,1))/(freq−shift(freq,1))
;remove edge effects
d2beta[1] = d2beta[2]
d2beta[0] = d2beta[1]
;third derivative
d3beta = (d2beta−shift(d2beta,1))/(freq−shift(freq,1))
;remove edge effects
d3beta[2] = d3beta[3]
d3beta[1] = d3beta[2]
d3beta[0] = d3beta[1]
;fourth derivative
d4beta = (d3beta−shift(d3beta,1))/(freq−shift(freq,1))
;remove edge effects
d4beta[3] = d4beta[4]
d4beta[2] = d4beta[3]
d4beta[1] = d4beta[2]
d4beta[0] = d4beta[1]
;fifth derivative
d5beta = (d4beta−shift(d4beta,1))/(freq−shift(freq,1))
;remove edge effects
d5beta[4] = d5beta[5]
d5beta[3] = d5beta[4]
d5beta[2] = d5beta[3]
d5beta[1] = d5beta[2]
d5beta[0] = d5beta[1]
;sixth derivative
d6beta = (d5beta−shift(d5beta,1))/(freq−shift(freq,1))
;remove edge effects
d6beta[5] = d6beta[6]
d6beta[4] = d6beta[5]
d6beta[3] = d6beta[4]
d6beta[2] = d6beta[3]
d6beta[1] = d6beta[2]
d6beta[0] = d6beta[1]
;choose which derivatives to use for dispersion correction
a1 = 0d;dbeta[nlambda/2]
a2 = 0.5d * d2beta[nlambda/2]
a3 = 1d/6d * d3beta[nlambda/2]
a4 = 0;1d/24d * d4beta[nlambda/2]
a5 = 0;1d/120d * d5beta[nlambda/2]
a6 = 0;1d/720d * d6beta[nlambda/2]
;compute the corrected phase at the desired position
cor_phase = phase − dist*(a1*(freq−freq[nlambda/2]) $
                + a2*(freq−freq[nlambda/2])\hat{ }2 $
                + a3*(freq−freq[nlambda/2])\hat{ }3 $
                + a4*(freq−freq[nlambda/2])\hat{ }4 $
                + a5*(freq−freq[nlambda/2])\hat{ }5 $
                + a6*(freq−freq[nlambda/2])\hat{ }6)
;compute the corrected data using the corrected phase
cor_data = complex(mag*cos(cor_phase), mag*sin(cor_phase))
return, cor_data
end
```

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. An alignment apparatus for aligning an interferometer, wherein the interferometer is configured for free space beam propagation, and wherein a misalignment of the interferometer is characterized by a reduced set of dominant degrees of freedom, the alignment apparatus comprising:
for each dominant degree of freedom:
detection means for detecting an alignment associated with the dominant degree of freedom and for providing an error signal associated with the dominant degree of freedom; and
a positioning element operatively connected to the interferometer and configured to vary the alignment associated with the dominant degree of freedom; and
a controller configured to control each positioning element and maintain alignment of the interferometer based on the error signals obtained from said detection means.

2. The alignment apparatus according to claim 1 where the dominant degrees of freedom are substantially independent.

3. The alignment apparatus according to claim 1 wherein one or more of the degrees of freedom is a beam tilt.

4. The alignment apparatus according to claim 3 further comprising a spatial filter, wherein the beam tilt is measurable with respect to said spatial filter.

5. The alignment apparatus according to claim 4 where said spatial filter is located at an output of the interferometer, said spatial filter including a focusing optical element and a reflective optical element comprising a pinhole.

6. The alignment apparatus according to claim 5 wherein said reflective optical element is a partially reflective optical element.

7. The alignment apparatus according to claim 5 where the beam tilt is measurable and controllable relative to the position of said pinhole.

8. The alignment apparatus according to claim 5 further comprising:
a beam sampling element for sampling a beam reflected form said reflective optical element;
an imaging detector; and
an additional optical element for reimaging said pinhole onto said imaging detector.

9. The alignment apparatus according to claim 1 wherein one or more of the degrees of freedom is beam shear.

10. The alignment apparatus according to claim 1 wherein one or more of the degrees of freedom is beam focus.

11. The alignment apparatus according to claim 1 wherein one or more of the degrees of freedom involves higher order aberrations.

12. The alignment apparatus according to claim 8 further comprising:
an additional beam sampling element for sampling one or more overlapping beams, thereby producing sampled beams;
an additional imaging detector configured to detect the sampled beams; and
an optical beam size conditioning subsystem for controlling a size of the sampled beams incident on said additional imaging detector.

13. An apparatus for aligning an interferometer, wherein the interferometer is configured for free space beam propagation, the apparatus comprising:
a spatial filter located at an output of the interferometer, said spatial filter including a focusing optical element and a reflective optical element including a pinhole;
a tilt detection subsystem configured to reimage said pinhole for measuring beam tilt;
a shear detection subsystem configured to image a beam offset for measuring beam shear; and
two or more positioning elements configured to vary said beam tilt and said beam shear.

14. The apparatus according to claim 13 wherein said positioning elements are configured to compensate for errors resulting from a reduced set of dominant degrees of freedom of the interferometer, such that one positioning element is provided for each reduced dominant degree of freedom.

15. The apparatus according to claim 14 wherein said reduced set of dominant degrees of freedom include two tilt axes and two shear axes.

16. The apparatus according to claim 13 wherein the interferometer includes an optical source and a collimating optical element for collimating the optical source, and wherein two of said positioning elements include a first automated horizontal translation device and a first automated vertical translation device for translating a lateral position of the optical source relative to the collimating optical element.

17. The apparatus according to claim 13 wherein the interferometer includes a reference arm including a retroreflector, wherein two of said positioning elements comprise a second automated horizontal translation device and a second automated vertical translation device for translating a lateral position of said retroreflector.

18. The apparatus according to claim 13 wherein said tilt detection subsystem comprises:
a beam sampling element for sampling a beam reflected from said reflective optical element;
an imaging detector; and
an additional optical element for reimaging said pinhole onto said imaging detector.

19. The apparatus according to claim 13 wherein said shear detection subsystem comprises:
an additional beam sampling element for generating a sampled beam;
an additional imaging detector for detecting the sampled beam; and
an optical beam size conditioning subsystem for controlling a size of the sampled beam incident on said additional imaging detector.

20. The apparatus according to claim 13 wherein said tilt detection subsystem and said shear detection subsystem include a common beam sampling element.

21. The apparatus according to claim 13 wherein said reflective optical element is partially reflective.

22. The apparatus according to claim 13 further comprising a processor configured to determine, based on signals obtained from said tilt detection subsystem and said shear detection subsystem, a tilt offset and a shear offset, and to provide correction signals to said two or more positioning elements for correcting the tilt offset and the shear offset.

23. The apparatus according to claim 22 further comprising a memory for storing calibration data associated with said positioning elements.

24. The apparatus according to claim 22 further comprising a first beam block configured to optionally block a first beam, and a second beam block configured to optionally block a second beam.

25. The apparatus according to claim 24 further comprising a detector for detecting optical beams transmitted through said pinhole and monitoring a performance of the interferometer, wherein said processor is further configured to control automated insertion of said first beam block into a path of said first beam and to control automated insertion of said second beam block into a path of said second beam, and wherein said processor is further configured to control an alignment of the interferometer by controlling said positioning elements while blocking said first beam and said second beam individually.

26. An optical coherence tomography system comprising an apparatus according to claim 1.

27. An optical system comprising an apparatus according to claim 1, said system further comprising the interferometer.

28. A method of aligning an interferometric system, the interferometric system including an interferometer configured for free space beam propagation and an alignment apparatus according to claim 13, wherein the positioning elements of the alignment apparatus are provided to compensate for errors resulting from a reduced set of dominant degrees of freedom for the interferometer, such that one positioning element is provided for each reduced dominant degree of freedom;
the method comprising the steps of:
a) determining a tilt offset from the tilt detection subsystem;
b) controlling at least one of the positioning elements to correct for the tilt offset;
c) determining a shear offset from the shear detection system; and
d) controlling at least one of the positioning elements to correct for the shear offset.

29. The method according to claim 28 further comprising repeating steps a) through d) one or more times.

30. The method according to claim 28 wherein the reduced set of dominant degrees of freedom include two tilt axes and two shear axes;
wherein the step of controlling the positioning elements to correct for the tilt offset includes controlling two tilt compensating positioning elements; and
wherein the step of controlling the positioning elements to correct for the shear offset includes controlling two shear compensating positioning elements.

31. The method according to claim 30 wherein the tilt detection subsystem includes a beam sampling element for sampling a collimated beam reflected from the reflective optical element, a first imaging detector, and an additional optical element for reimaging the pinhole onto the imaging detector; and wherein the step of determining the tilt offset includes the steps of:
performing a comparison of a centroid of a spot recorded on the first imaging detector to a previously recorded centroid, wherein the previously recorded centroid corresponds to the initial aligned state; and
calculating a tilt offset based on the comparison.

32. The method according to claim 31 wherein the step of controlling the positioning elements to correct for the tilt offset includes the steps of:
obtaining calibration data relating to the tilt compensating positioning elements;
controlling the tilt compensating positioning elements to apply a suitable correction to correct for the tilt offset.

33. The method according to claim 30 wherein the shear detection subsystem includes an additional beam sampling element for sampling a first beam and a second beam, an additional imaging detector for detecting the first and second beams obtained from the additional beam sampling element, and an optional optical beam size conditioning subsystem for controlling a size of the first beam and the second beam incident on the additional imaging detector;
wherein the step of determining the shear offset includes the steps of:
recording an image corresponding to pupils of the first beam and the second beam;
obtaining previously recorded images of individual pupils of the first beam and the second beam; and
extracting the shear offset by a comparing the image to a positionally dependent sum of the previously recorded images.

34. The method according to claim 33 wherein the step of controlling the positioning elements to correct for the shear offset comprises the steps of:
obtaining calibration data relating to the shear compensating positioning elements;
controlling the shear compensating positioning elements to apply a suitable correction to correct for the shear offset.

35. The method according to claim 28 further comprising the steps of:
measuring a signal relating to a performance of the interferometric system;
inferring an overall alignment quality of the interferometric system; and
performing the following additional steps when the overall alignment quality is below a pre-defined criterion:
blocking a second beam and correcting an alignment of a first beam by controlling one or more positioning elements affecting propagation of the first beam; and
blocking the first beam and correcting an alignment of the second beam by controlling one or more positioning elements affecting propagation of the second beam;
wherein the one or more positioning elements affecting propagation of the second beam are not common to the one or more positioning elements affecting propagation of the first beam.

36. The method according to claim 28, wherein the steps are performed by a processor, wherein the processor is configured to obtain the tilt offset and the shear offset and to control the positioning elements.
